(19) United States
(12) Patent Application Publication
(10) Pub. No.: US 2025/0310079 A1
(43) Pub. Date: Oct. 2, 2025

(54) METHOD OF GENERATING AND COMMUNICATING A DIGITAL AGENCY CAPSULE

(71) Applicant: Synovient, Inc., Scottsdale, AZ (US)

(72) Inventors: Katalin K. BARTFAI-WALCOTT, El Dorado Hills, CA (US); Donald E. LAKE, III, Denver, CO (US); John S. WALCOTT, El Dorado Hills, CA (US); Matthew ROYER, Hillsboro, OR (US); Richard FOOTE, Portland, OR (US); Vasuki CHILUKURI, Portland, OR (US)

(21) Appl. No.: 19/097,481

(22) Filed: Apr. 1, 2025

Related U.S. Application Data
(60) Provisional application No. 63/573,346, filed on Apr. 2, 2024.

(51) Int. Cl. H04L 9/00; H04L 9/08; H04L 9/40

(52) U.S. Cl. CPC H04L 9/008; H04L 9/0861; H04L 63/166

(57) ABSTRACT

A method for data encapsulation includes: receiving, at a user interface, an indication of content associated with a content owner; receiving one or more governance policies corresponding to the content, wherein the one or more governance polices include one or more parameters, the one or more parameters defining parameter characteristics of the content and include at least one of an accessing parameter, a sharing parameter, and a utilizing parameter; generating at least one data object based on the content and the one or more parameters; and performing an encapsulation process to bind the at least one data object with the one or more governance policies into an digital agency capsule.

### CROSS REFERENCE TO RELATED APPLICATIONS

This U.S. Non-Provisional Patent Application claims the benefit of U.S. Provisional Patent Application Ser. No. 63/573,346 titled “METHOD OF GENERATING AND COMMUNICATING A DIGITAL AGENCY CAPSULE” filed Apr. 2, 2024, and Provisional Patent Application Ser. No. 63/575,989 titled “DIGITAL AGENCY CAPSULE ARCHITECTURE” filed Apr. 2, 2024, the entire disclosures of which are hereby incorporated by reference.

### BACKGROUND

### Field of the Disclosure

Aspects of the present disclosure pertain to the field of digital content management, focusing on the secure and governed distribution of digital assets. Specifically, the present disclosure relates to a system for encapsulating digital content—such as images, videos, documents, artificial intelligence (AI)-generated materials, and executables (e.g., including operating system kernels, websites, applications, and the like)—alongside clearly defined governance policies that dictate the terms of access, usage, and distribution. The system facilitates and manages the secure communication and secure transmission (e.g., including management of the terms and conditions and the associated rules and execution of the rules) of this encapsulated content, ensuring its integrity, authenticity, and compliance with the established governance policies across various platforms and stakeholders. Additionally, the system of the present disclosure may be configured to manage access to groups of objects, individual objects, and to provide the ability to see, perceive, and/or have knowledge pertaining to one or many objects that are not part of an entity's access level.

### Description of Related Art

A cloud platform (i.e., a computing platform for cloud computing) may be employed by many users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.). Additionally, or alternatively, the user may access the cloud platform using a hybrid solution, where the management and access is across platforms (e.g., stored remotely and accessed locally). In one example, the cloud platform may support management solutions, such as sales, service, marketing, community, analytics, applications, and the Internet of Things.

In some cases, using a cloud platform, or any suitable platform, may encounter one or more problems. For example, there may be a deficiency in an amount of control and transparency over data usage, ownership, and privacy when using the cloud platform. Additionally or alternatively, security risks (e.g., data breaches) may be present when using a cloud platform and/or other data storage, data management, and data processing systems. For example, personal information (e.g., stored using cloud platforms) may be at risk of being stolen, being compromised, and/or being used for malicious intents. Additionally or alternatively, personal information may be commoditized without explicit consent from an individual or without benefit to the individual.

While described with reference to a cloud platform and using the cloud platform to handle storage, management, transport, and processing of data (e.g., content as described herein), the described techniques herein may be related to, but supersede, other prior methods and systems of storage, transmission, and access (e.g., such as cloud systems, edge systems, server systems, personal computing systems, mobile computing systems, and/or any other suitable computing systems).

### SUMMARY

One aspect provides a method for data encapsulation by an apparatus. The method includes receiving, from a content owner, an indication of content; receiving, from the content owner, one or more governance policies corresponding to the content, wherein the one or more governance polices comprise one or more parameters for accessing, transporting, sharing, utilizing, or a combination thereof, of the content; and performing an encapsulation process to bind the content with the one or more governance policies into a self-contained unit.

Another aspect provides a method for sending encapsulated content by an apparatus. The method includes receiving, from a user, an access request to access a self-contained unit, wherein the self-contained unit comprises a content bound to one or more governing policies; establishing a connection between the user and a content owner of the self-contained unit based at least in part on receiving the request; and sending, to the user, a permit signal based at least in part on establishing the connection, wherein the permit signal enables the user to access the content in the self-contained unit according to the one or more governing policies.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors (e.g., or any type of processor or processors, including but not limited to central processing units (CPUs); graphics processing units (GPUs); digital signal processors (DSPs); neural processing units (NPUs); tensor processing units (TPUs); field-programmable gate arrays (FPGAs); application-specific integrated circuits (ASICs); trusted platform modules (TPMs); secure enclave processors; hardware security modules (HSMs); microcontrollers (MCUs); network processors; quantum processors; and processors deployed in cloud, edge, or virtualized environments, including container-based and multitenant architectures. The processors may operate individually or in a distributed fashion across multiple devices, physical or virtual) in a distributed fashion (e.g., or a federated fashion), such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion).

By way of example, an apparatus may comprise a processing system, a device with a processing system, or processing systems cooperating and collaborating (e.g., hive and mesh) over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example of a system for encapsulating content with defined governing logic for the content in accordance with aspects of the present disclosure.

FIG. 2 depicts an example system for encapsulating content with defined governing logic for the content in accordance with aspects of the present disclosure.

FIG. 3 depicts an example process for creating a digital agency capsule (DAC) for encapsulating content with defined governing logic for the content in accordance with aspects of the present disclosure.

FIG. 4 depicts an example process for sending a DAC in accordance with aspects of the present disclosure.

FIG. 5 depicts a method for data encapsulation in accordance with aspects of the present disclosure.

FIG. 6 depicts a method for sending encapsulated content in accordance with aspects of the present disclosure.

FIG. 7 depicts aspects of an example device that is configured to create and/or send a DAC in accordance with aspects of the present disclosure.

FIG. 8 depicts a diagram of a system including a device that supports encapsulating content with defined governing logic for the content in accordance with aspects of the present disclosure.

### DETAILED DESCRIPTION

Aspects of the present disclosure provide apparatuses, methods, processing systems, and computer-readable mediums for a digital agency capsule (DAC) that employs one or more encapsulation processes to bind content to governing logic defined for the content. For example, the one or more encapsulation processes may bind the content to use rules, lifecycle management protocols, and/or contractual terms for the content to form a DAC, and the DAC may be directly linked to an owner of the content. In some aspects, the DAC (e.g., encapsulated content that is bound to the defined governing logic) may ensure that, no matter where the content resides (e.g., in a cloud platform, on a remote server, on a device of the content owner, etc.), the content may remain under the control of its rightful owner and that the content is used strictly according to predefined terms (e.g., the defined governing logic).

In some aspects, the content may include one or more multimedia files (e.g., including images, audio files, videos, etc.) that can be encapsulated within a DAC, where the DAC may be configured or defined to protect artistic works, promotional materials, and personal media corresponding to the multimedia files from unauthorized access and alterations. Additionally or alternatively, the content may include textual content (e.g., documents, press releases, articles, social media posts, etc.) that can be encapsulated within a DAC, and the DAC may be configured or defined to ensures that textual representations of an individual or brand are distributed and used according to specified governance policies (e.g., the defined governing logic). Additionally or alternatively, the content may include software and/or code (e.g., software binaries, source code, applications, code for applications, etc.) that can be encapsulated within a DAC. And the DAC may be configured or defined to protect intellectual property (e.g., corresponding to the software and/or code) and ensure distribution of the software and/or code complies with licensing terms (e.g., the defined governing logic).

The DAC may address one or more technical problems in digital storage and/or digital communications, such as the lack of control and transparency over usage, ownership, and privacy of content (e.g., data). In an era where data breaches are commonplace and personal information is often commoditized without explicit consent or benefit to the individual, the DAC may introduce a paradigm shift by redefining how data is managed, accessed, and monetized. In current practices, content may escape the owner's control (e.g., an owner of the content) after the content is shared, leading to potential misuse and/or unauthorized access.

The DAC may employ encryption and cryptography processes and techniques. Through the use of advanced encryption techniques, the DAC may ensure that content is accessible only to parties who meet the specified conditions (e.g., the defined governing logic) set by the content owner. This may protect the content from unauthorized access and may maintain its integrity by ensuring that any attempt to alter the content or its associated contract without permission corrupts the DAC, rendering the content inaccessible. This mechanism may enforce the bond between the content and its governance rules (e.g., the defined governing logic), making them inseparable and immutable.

In some aspects, the DAC may address a critical technical problem in the realm of identity and access management (IAM) by ensuring that access and usage of content are intrinsically tied to the identity of the user and governed by precise, pre-defined rules set by the data owner or agent (e.g., the defined governing logic). Traditionally, IAM systems have struggled to seamlessly integrate governance and user access controls for content, often resulting in either overly restrictive access policies that hinder legitimate utilization of content or too lenient controls that expose content to potential misuse. The DAC may overcome these challenges by embedding governance policies (e.g., the defined governing logic) directly within the content itself, making these policies inseparable from the content no matter where the content or DAC resides or how the content or DAC is accessed. This approach may simplify enforcement of access controls based on user identity and may also allow for dynamic adjustment of permissions in real-time based on compliance with these embedded rules (e.g., the defined governing logic). As a result, the DAC framework may offer a more granular, flexible, and secure method of managing access to digital assets (e.g., the content), ensuring that only authorized users can access content under conditions explicitly approved by the data owner, thereby enhancing both security and usability in digital ecosystems.

In some aspects, DAC and IAM systems may be fundamentally concerned with controlling access to digital assets and resources. DAC and IAM systems may implement security measures to ensure only authorized individuals or entities can access specific data or content. This shared focus on security and access control may reflect the roles of DAC and IAM systems in protecting sensitive information and intellectual property from unauthorized use or exposure. Additionally, both systems may aim to streamline and secure digital operations, whether related to content distribution in the case of the DAC systems or user access and permissions in the case of IAM systems.

The DAC may be primarily designed to encapsulate digital content and governance policies into a secure, self-contained unit. This approach ensures that the content and its usage rules travel together, regardless of where the content is stored or shared. The DAC focuses on the content, embedding rules for how the content can be accessed, used, and distributed, and applies regardless of the user's identity. IAM systems, on the other hand, may be focused on managing and verifying the identities of users and controlling their access to resources within a network or system. IAM systems do not concern themselves directly with the content but rather with who has access to the content, managing permissions based on roles, attributes, or group memberships. Additionally, the DAC may incorporate governance policies directly with the content, addressing compliance, usage rights, and distribution controls at the content level. The DAC may provide a mechanism for content creators to specify and enforce how their digital assets are used across different platforms. Alternatively, IAM systems may deal with governance and compliance from an identity perspective, ensuring access controls are in place to meet organizational policies and regulatory requirements. IAM systems may focus on authenticating users and authorizing access based on predefined policies.

Additionally, the DAC may employ advanced encryption techniques, digital signatures, and potentially blockchain technology to secure digital content and verify its authenticity and integrity. This DAC technology may be geared towards content protection, integrity verification, and policy enforcement. Alternatively, IAM systems may utilize authentication protocols, directory services, and access management policies to manage user identities and permissions. This IAM technology may be centered on user verification, password management, single sign-on (SSO) services, and multi-factor authentication (MFA). In some aspects, the DAC may be designed to be interoperable across various platforms and digital ecosystems, ensuring that encapsulated content and its governance policies are maintained irrespective of the distribution channel. The broad application of the DAC may encompass any digital content requiring protection and managed distribution. Alternatively, IAM systems must integrate with various information technology (IT) infrastructure components, applications, and services within an organization. While IAM may be crucial for securing access across different systems, its interoperability may focus on seamless user authentication and access management within organizational boundaries.

While the DAC and IAM systems may share a common goal of securing digital assets and resources, the DAC may be content-centric, embedding security and governance policies directly with the digital content. In contrast, IAM systems may be identity-centric, focusing on managing user identities and their permissions to access resources. Both play complementary roles in the broader digital security and data management context, addressing different aspects of the digital content and access control infrastructure.

The DAC may incorporate the concept of data agency for management of the content in the DAC, empowering individuals and organizations with control over their digital assets (e.g., the content). This control may extend beyond access permissions, enabling data agents to actively define and manage how their data is used throughout its lifecycle, which may be achieved by applying one or more Distributed Computing Environment (DCE) principles, which facilitate the distribution of DAC services across various platforms and networks, ensuring seamless and secure data access and control.

Further, the DAC may address a technical challenge of autonomous management of contractual data access terms based on predefined rules set by the data agent. This functionality, absent in traditional computing enclaves and other Digital Rights Management (DRM) solutions, may introduce a dynamic, autonomous control over data access, enhancing security and flexibility. The design of the DAC may emphasize portability and encapsulation, ensuring that data and its governance rules remain intact and enforceable, regardless of the storage location. This design may contrast with the dependency of traditional computing enclaves on specific hardware or system architecture, offering a more flexible and resilient solution to data management.

In solving these above described technical problems, the DAC may enhance data security and privacy and may open new avenues for data futures trade, monetization, and remuneration. By enabling data agents to set and manage terms for data access, the DAC may introduce a model where data access can be monetized through smart micro- payments, shifting the economic value of data towards owners of content. This may represent an improvement over traditional paywalls, subscriptions, and data licensing mechanisms, providing a fairer and more equitable economic model for data utilization.

Additionally, the DAC may solve a critical technical problem of ensuring data control, privacy, and monetization in the digital age. By encapsulating content with its use rules and contractual terms (e.g., defined governing logic), employing advanced encryption and cryptography for security of the content, and empowering data agents with unprecedented control over their digital assets, the DAC may represent a transformative approach to data management. This solution may protect data integrity and privacy, foster innovation, and create economic opportunities, enhancing governance of content that aligns with the values of transparency, security, and empowerment.

The DAC may offer customers unparalleled control and security over their content, marking a significant advancement in the way that personal and organizational content is managed and utilized. For customers, this may translate into a more secure digital experience, where the risk of data breaches and unauthorized access is greatly minimized. By integrating governance directly with the content itself, the DAC may ensure that customer data and/or content cannot be used without explicit adherence to predefined rules and conditions (e.g., the defined governing logic). This level of control may empower customers, allowing them to dictate the terms of usage, access, and lifecycle of the content. Such empowerment may be particularly relevant in today's data-driven world, where concerns over privacy and misuse of information are ever-present. Customers may benefit from the peace of mind that comes with knowing their content is protected by state-of-the- art encryption and cryptographic safeguards, ensuring their information remains confidential and secure.

Further, the DAC may include a dynamic permissions model, which hinges on the periodic refresh of a permit signal. Accordingly, the dynamic permissions model may offer customers an ongoing assurance that their content is being used in compliance with their stipulated terms (e.g., the defined governing logic). This real-time governance mechanism may be a proactive approach to data management, automatically revoking access if terms are breached or compliance reports are not submitted. For customers, this means that their content may remain in a protected state and may be accessible only under conditions the customers have approved or agreed to. This continuous, automated monitoring and enforcement of access permissions may significantly reduce the likelihood of unauthorized exploitation of the content, enhancing trust in digital transactions and interactions. Additionally, the DAC may adapt permissions in real time according to compliance status, which may simplify governance of the content for customers and also may represent a leap forward in protecting digital rights and autonomy.

Additionally, the economic advantages presented by the DAC may open new avenues for content owners (e.g., customers) to monetize their content in a secure and controlled manner. By allowing content owners to set specific terms for content access and usage, the DAC may facilitate a direct means of remuneration for the use of their content (e.g., data assets). This capability may foster a more equitable economic model where content owners can derive tangible benefits from their content, challenging traditional paradigms of content monetization dominated by large corporations. Additionally, the secure data sharing enabled by the DAC may catalyze innovation across industries, potentially leading to the development of new services and technologies that content owners can benefit from. This may enhance the value derived from their content and may also contribute to a more transparent, ethical, and innovative digital ecosystem, where the rights and interests of content owners are at the forefront.

In some embodiments, the DAC may comprise an architected as a secure, encapsulated digital container specifically designed to uphold rigorous data sovereignty, licensing compliance, and enforceable usage control of digital assets. Each DAC uniquely identifies its data asset and associated agent through a cryptographically secure DAC Ownership ID, established during an initialization phase. This DAC Ownership ID and embedded metadata describing licensing terms and conditions ensure that ownership and authorization are verifiable, immutable, and persistently enforced throughout the data lifecycle. The DAC system carefully preserves the original data attributes, explicitly maintaining original filenames and extensions, while seamlessly embedding DAC metadata, ensuring the user's interaction remains intuitive and imperceptible, with minimal friction in user workflows.

Operationally, the DAC lifecycle involves clearly delineated stages (e.g., initialization, configuration, instantiation, distribution, and/or ongoing management). During initialization and configuration, the data owner authenticates and credentials their identity, defining enforceable, immutable licensing terms through templates. Subsequent instantiation of the DAC occurs when specific digital assets are identified for encapsulation. The DAC may undergo a rigorous validation sequence, incorporating the DAC Ownership ID, asset metadata, and licensing terms to ensure completeness and accuracy prior to distribution or usage. Throughout distribution and subsequent interactions, the DAC Management System (DACMS) continuously monitors and validates user access, logging each interaction, and verifying adherence to licensing conditions in real-time. Continuous permission refresh cycles reaffirm authorization validity, effectively providing real-time enforcement and auditability.

Security within the DAC framework operates on multiple layers, encompassing both internal and external measures. Internally, the DAC employs encryption, authentication, and metadata tagging to ensure data integrity and confidentiality, protecting the content both at rest and in transit. Externally, DAC metadata is transparently communicated to users through intuitive mechanisms such as hover-over tooltips and context menus, clearly signaling DAC enablement and licensing requirements. Furthermore, the DAC mandates strict inheritance rules: any derivative or subsequent content incorporating DAC-protected assets automatically inherits the original terms and conditions, ensuring persistent protection. New licensing conditions applied to derivatives are permissible only if they provide more restrictive terms, preserving the fidelity and intent of the original data asset's licensing.

The DAC thus provides an integrated, comprehensive approach to digital asset protection, offering transparent, enforceable data control that preserves the agent's sovereignty across diverse digital platforms and ecosystems. Its architecture uniquely addresses current gaps in traditional digital rights and data management technologies by embedding enforceable metadata at the file level, integrating seamless user experience, rigorous compliance management, proactive security validation, and persistent ownership enforcement. This strategic combination of technical capability and usability ensures the DAC meets modern digital asset protection demands, effectively preventing unauthorized access, modification, or misuse, while providing the data owner unparalleled visibility and control throughout the data lifecycle.

The DAC system is architected to operate independently of underlying infrastructure, providing significant flexibility to customers across diverse deployment environments. While the DAC does not rely on specific hardware or software components, it can seamlessly integrate infrastructure-based accelerators, such as specialized hardware encryption modules or high-performance cryptographic services, to enhance operational performance when the customer desires. Furthermore, the security architecture of the DAC is intentionally modular, enabling customers to adopt a plug-and-play approach to security implementation. This modularity allows customers to integrate customized or preferred security solutions, including industry-standard encryption algorithms, third-party authentication modules, or specialized access control mechanisms, based on their unique regulatory or operational requirements. Additionally, key management within the DAC ecosystem offers exceptional flexibility: customers may choose simple key models provided directly by the system, rotating keys to periodically refresh cryptographic protection, multi-party keys where control is distributed across multiple stakeholders, or partial keys requiring collaborative assembly for data access. The DAC system also supports key expiration and revocation capabilities, enabling customers to proactively terminate access and securely close DAC-protected data assets, thus reinforcing data sovereignty and security throughout the entire digital content lifecycle.

In some embodiments, the DAC may be configured to support multiple data files encapsulated as individual objects within a single DAC container. Each file is independently managed with a unique ContentID, which distinctly identifies the asset within the DAC. This granular identification enables precise management of each object's metadata, permissions, and access keys. The DAC may comprise structured hierarchy and modularity, allowing data assets to be logically grouped into Data Asset Groups, each governed by tailored permission schemes and individualized terms and conditions. This modular permission scheme and management approach empowers DAC creators with the flexibility to define fine-grained, content-specific licensing, access control, and cryptographic keying, ensuring security and operational precision at the object level while maintaining broader DAC-level governance.

At the object level, each encapsulated data asset maintains dedicated cryptographic keys, individually configurable permissions, and customizable licensing terms. This allows the data agent to provide differentiated access ranging from fully restricted, limited-customized access, or broadly open access according to business, regulatory, or strategic needs. At the overarching DAC level, higher-level terms and conditions, permissions, and keys apply uniformly across all contained objects, enforcing universal standards or requirements. The interplay between DAC-level and object-level controls enables multi-tiered security and compliance enforcement, ensuring comprehensive protection that matches the nuanced requirements of each encapsulated data object and overall DAC strategy.

In some embodiments, the DAC architecture may be immutable. Once a DAC is instantiated and finalized, the DAC and its internal content objects, terms and conditions, cryptographic keys, permissions, and associated metadata cannot be altered or modified. This immutability ensures absolute integrity and authenticity of the encapsulated data and associated governance parameters throughout their entire lifecycle. Any changes or updates necessitate the creation of a new DAC instance, preserving an auditable and trustworthy history of data interactions. The immutable nature also ensures that licensing terms, compliance obligations, and data ownership rights remain consistently enforced, safeguarding data sovereignty and operational trust.

In some embodiments, the DAC may support extensive flexibility in key management and security implementation. Users can specify how cryptographic keys are handled, whether utilizing a simple, single-user key, rotating keys for enhanced security, partial keys requiring multi-party cooperation, or key expiry mechanisms to proactively revoke access. Security modules may be fully modular and pluggable, allowing customer-specific encryption algorithms, authentication mechanisms, or compliance protocols to be integrated. This infrastructure-independent approach ensures seamless DAC deployment across diverse computing environments, with optional support for accelerators or specialized security hardware if desired. The DAC may be configured to provide robust, precise, and adaptable data protection suitable for complex, multi-object data sovereignty scenarios.

In some embodiments, the systems and methods described herein may be configured to generate a DAC, accommodating user preferences and workflows. The systems and methods described herein may be configured to initialize an empty DAC without specifying or inserting the data assets it will protect. The systems and methods described herein may be configured to provision the DAC with all essential identifiers, licensing terms, cryptographic keys, permissions, and metadata frameworks, effectively creating a secure but open digital container ready to receive data at a future point. The DAC may be in an “open” state, prepared to accept content according to the owner's timeline and operational readiness. The systems and methods described herein may be configured to, responsive to receiving assets, securely encapsulate the assets within the already established DAC framework. The DAC inherits the predefined terms, conditions, and security mechanisms, immediately activating comprehensive protection and immutability enforcement. The systems and methods described herein may be configured to provide flexibility, allowing for time management and coordination separately from initial DAC setup activities.

In some embodiments, the systems and methods described herein may be configured to integrate data encapsulation directly and proactively with the DAC creation workflow. The systems and methods described herein may be configured to identify the specific digital assets requiring protection at the beginning of the process. The systems and methods described herein may be configured to initiate immediate preparation of data content, licensing terms, and permission association at the asset-level, organizing the data into structured, individually identifiable objects. The systems and methods described herein may be configured to, in response to desired terms and security mechanisms being defined, encapsulate the assets within the DAC concurrently with DAC creation, resulting in a fully instantiated and secured DAC after the process. This approach benefits users with clearly defined data protection goals upfront and prefer to establish full data sovereignty, licensing clarity, and enforceable access controls simultaneously with DAC instantiation, ensuring immediate and comprehensive protection of their digital assets.

In some embodiments, the DAC architecture delivers an extensive array of services and interfaces, designed for highly secure, adaptable, and seamless integration into existing and emerging environments. The DAC may leverage APIs for standard interactions, and/or may accommodate alternative interface types, including message queues, event streams, direct database connectors, and file-based interactions, based on customer preferences and integration requirements. This flexibility allows the use of DAC capabilities across diverse operational scenarios, infrastructures, and technology stacks, enhancing usability and integration simplicity. The DAC services systematically expose detailed metrics, telemetry, metadata, and other critical operational data necessary for precise control, continuous monitoring, and proactive governance.

In some embodiments, the DAC interfaces may provide comprehensive visibility into provenance, data ownership, data agency, and chain-of-custody, thereby ensuring transparency, auditability, and verifiable accountability throughout the entire lifecycle of digital assets. DAC generated telemetry and metrics support rigorous compliance validation, forensic audits, real-time transaction monitoring, and active license enforcement, further strengthening the integrity and trustworthiness of data transactions and interactions. By explicitly capturing and exposing these detailed provenance and metadata elements, the DAC may be configured to enhance organizational capabilities to confidently enforce data sovereignty, traceability, and governance standards across highly distributed, multi-party digital ecosystems.

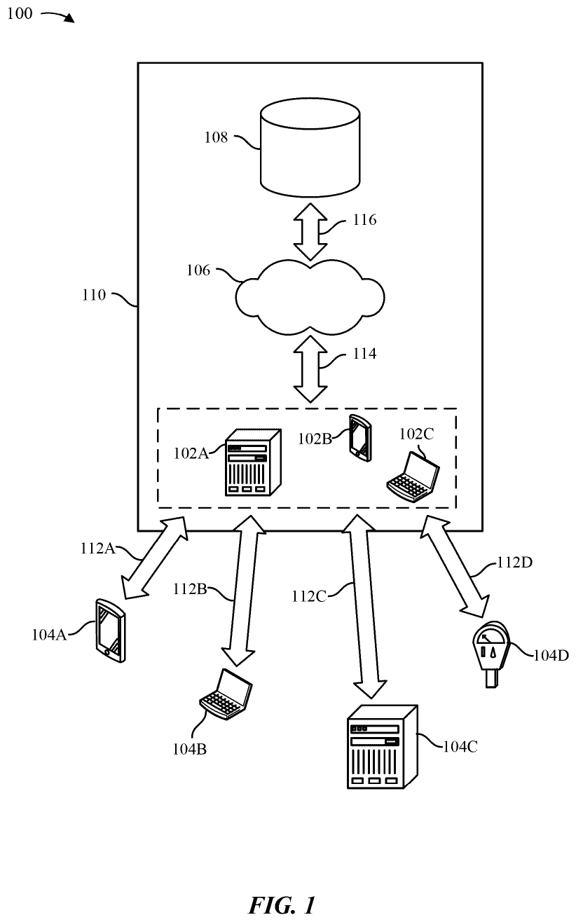

FIG. 1 illustrates an example of a system 100 for cloud computing that supports modifying default display configurations for objects in a user interface in accordance with various aspects of the present disclosure. The system 100 may include cloud clients 102, contacts 104, cloud platform 106, and data center 108. Cloud platform 106 may be an example of a public or private cloud network. A cloud client 102 may access cloud platform 106 over a network connection 114. The network may implement transfer control protocol and internet protocol (TCP/IP), such as the Internet, or may implement other network protocols. A cloud client 102 may be an example of a user device, such as a server (e.g., cloud client 102A), a smartphone (e.g., cloud client 102B), or a laptop (e.g., cloud client 102C). In other examples, a cloud client 102 may be a desktop computer, a tablet, a sensor, or another computing device or system capable of generating, analyzing, transmitting, or receiving communications. In some examples, a cloud client 102 may be operated by a user that is part of a business, an enterprise, a non-profit, a startup, or any other organization type.

A cloud client 102 may interact with multiple contacts 104. The interactions 112 may include communications, opportunities, purchases, sales, or any other interaction between a cloud client 102 and a contact 104. Data may be associated with the interactions 112. A cloud client 102 may access cloud platform 106 to store, manage, and process the data associated with the interactions 112. In some cases, the cloud client 102 may have an associated security or permission level. A cloud client 102 may have access to certain applications, data, and database information within cloud platform 106 based on the associated security or permission level and may not have access to others.

Contacts 104 may interact with the cloud client 102 in person or via phone, email, web, text messages, mail, or any other appropriate form of interaction (e.g., interactions 112A, 112B, 112C, and 112D). The interaction 112 may be a business-to-business (B2B) interaction or a business-to-consumer (B2C) interaction. A contact 104 may also be referred to as a user, a customer, a potential customer, a lead, a client, or some other suitable terminology. In some cases, the contact 104 may be an example of a user device, such as a smartphone (e.g., contact 104A), a laptop (e.g., contact 104B), a server (e.g., contact 104C), or a sensor (e.g., contact 104D). In other cases, the contact 104 may be another computing system. In some cases, the contact 104 may be operated by a user or group of users. The user or group of users may be associated with a business, a manufacturer, or any other appropriate organization.

Cloud platform 106 may offer an on-demand database service to the cloud client 102. In some cases, cloud platform 106 may be an example of a multi-tenant database system. In this case, cloud platform 106 may serve multiple cloud client 102 with a single instance of software. However, other types of systems may be implemented, including—but not limited to—client-server systems, mobile device systems, and mobile network systems. In some cases, cloud platform 106 may support CRM solutions. This may include support for sales, service, marketing, community, analytics, applications, and the Internet of Things. Cloud platform 106 may receive data associated with contact interactions 112 from the cloud client 102 over network connection 114 and may store and analyze the data. In some cases, cloud platform 106 may receive data directly from an interaction 112 between a contact 104 and the cloud client 102. In some cases, the cloud client 102 may develop applications to run on cloud platform 106. Cloud platform 106 may be implemented using remote servers. In some cases, the remote servers may be located at one or more data centers 108.

Data center 108 may include multiple servers. The multiple servers may be used for data storage, management, and processing. Data center 108 may receive data from cloud platform 106 via connection 116, or directly from the cloud client 102 or an interaction 112 between a contact 104 and the cloud client 102. Data center 108 may utilize multiple redundancies for security purposes. In some cases, the data stored at data center 108 may be backed up by copies of the data at a different data center (not pictured).

Subsystem 110 may include cloud clients 102, cloud platform 106, and data center 108. In some cases, data processing may occur at any of the components of subsystem 110, or at a combination of these components. In some cases, servers may perform the data processing. The servers may be a cloud client 102 or located at data center 108.

In some cases, using cloud platform 106 may encounter one or more problems. For example, there may be a deficiency in an amount of control and transparency over data usage, ownership, and privacy when using cloud platform 106. Additionally or alternatively, security risks (e.g., data breaches) may be present when using cloud platform 106 and/or other data storage, data management, and data processing systems. For example, personal information (e.g., stored using cloud platforms) may be at risk of being stolen, being compromised, and/or being used for malicious intents. Additionally or alternatively, personal information may be commoditized without explicit consent from an individual or without benefit to the individual.

While described with reference to cloud platform 106 and using cloud platform 106 to handle storage, management, and processing of data (e.g., content as described herein), the described techniques herein may be related to, but supersede, other prior methods and systems of storage, transmission, and access (e.g., such as cloud systems, edge systems, server systems, personal computing systems, and other computing systems).

Encryption technologies have long been the cornerstone of content security, ensuring that content is unreadable to unauthorized parties. However, encryption alone does not solve the problem of ownership and control of content. Once content is decrypted for use, enforcing how the content is subsequently handled or shared is challenging.

DRM systems were introduced to address the issue of controlling and enforcing the rights over digital media. While DRM provides a means to restrict how digital content is accessed and used, it has been criticized for being overly restrictive and infringing on user rights. Additionally, DRM systems often rely on specific hardware or software environments, limiting their flexibility and portability.

Another approach to enhancing content privacy and security has been previously employed through using secure computing environments, such as trusted execution environments (TEEs) and hardware security modules (HSMs). These technologies provide a secure space for processing sensitive information, protecting the sensitive information from unauthorized access even if the system is compromised. However, these solutions are typically tied to specific hardware, making them less adaptable and potentially creating silos of secure content that are difficult to integrate.

Blockchain technology has also been touted as a solution for ensuring content integrity and facilitating secure, transparent transactions. While blockchain offers immutability and transparency, it does not inherently provide privacy, and the public nature of many blockchains can lead to challenges in managing content ownership and control in a nuanced manner.

Accordingly, as described herein, a DAC is provided that may use an advanced data encapsulation technology to seamlessly merge content with its governance framework (e.g., defined governing logic and/or one or more governing policies), including usage policies, lifecycle management rules, and contractual terms. This encapsulation may ensure that the governance mechanisms are intrinsically linked to the content, regardless of where the content resides or how the content is used. Integration of the content with its control parameters may be facilitated through sophisticated encryption and cryptographic techniques, which safeguard integrity and confidentiality of the content. The DAC may also enable the autonomous enforcement of access and usage rules set forth by the content owner or agent, thereby establishing a secure and controlled environment for handling content that respects ownership rights and privacy considerations.

The DAC may employ a dynamic permissions model operationalized through a periodic refresh of a permit signal to maintain continuous compliance with the agreed- upon terms of use. This dynamic permissions model may hinge on real-time communication (e.g., near real-time, periodic, on request, push-pull, etc.) between a user's system and a content owner or agent's system to verify adherence to the contractual terms. In some aspects, compliance may be evidenced by regular reports from the user's system, which may in turn sustain the permit signal that allows access to content. Failure to provide these reports or a breach of contract terms may result in an automatic revocation of the permission signal, rendering the content inaccessible and the DAC in a deny state. This mechanism may ensure that content usage consistently aligns with the owner's stipulations, fostering a trust-based relationship between content owners and users.

The underlying technological infrastructure of the DAC may incorporate secure communication protocols to facilitate the exchange of compliance reports and the management of the permission signal. Cryptography may protect these communications and ensure that the permit signal and compliance status are transmitted securely and remain tamper-proof. This infrastructure may support a responsive and adaptive governance model that can adjust permissions in real-time (e.g., near real-time, periodic, on request, push-pull, etc.) based on compliance status, offering a significant advancement over static, manual data management practices. The core technology of the DAC (e.g., with its emphasis on data encapsulation, dynamic permissions, and secure communications) may present a transformative approach to data privacy, security, and ownership, promising a more ethical and equitable digital future.

In some aspects, the DAC may provide a robust solution that aligns seamlessly with global and regional data protection regulations such as the General Data Protection Regulation (GDPR) in the European Union, the California Consumer Privacy Act (CCPA) in the United States, and the Health Insurance Portability and Accountability Act (HIPAA). By design, the DAC may enhance compliance with these regulations through its inherent data protection, privacy, and governance mechanisms.

Under GDPR, the DAC may offer a structured approach to data management that prioritizes user consent, data minimization, and the right to erasure—all key principles of GDPR. The ability of the DAC to encapsulate content with its governance may ensure that content (e.g., personal data) is not just protected but that its usage strictly adheres to the conditions set by the content subject. This direct integration of governance with the content may address GDPR requirements for explicit consent and purpose limitation by enforcing access and usage rules as defined by the content owner. Further, the DAC may include a dynamic permissions model (e.g., which allows for real-time revocation of data access) to empower individuals with the right to withdraw consent, effectively enabling the content to revert to an inaccessible state, thereby facilitating compliance with the right to erasure or “right to be forgotten.”

In the context of CCPA, the DAC may enhance the rights of California residents by providing greater control over personal information. The CCPA emphasizes consumers' rights to know about, delete, and opt-out of the sale of their personal information. The DAC may include a governance model to ensure that content owners can easily enforce these rights, as the content and its use conditions are inseparably linked. By allowing content owners to specify and enforce the terms under which their information is accessed and used, the DAC may inherently support the CCPA's aim to empower consumers regarding their personal data. The transparency and control mechanisms of the DAC may align with the CCPA's goals, offering a proactive approach to privacy that can significantly reduce the complexity and cost of compliance for organizations.

Regarding HIPAA, which sets the standard for protecting sensitive patient data in the United States, the DAC may ensure that healthcare information is handled with the utmost security and privacy. The encryption and data governance capabilities of the DAC may ensure that PHI (Protected Health Information) is accessed and used strictly in accordance with HIPAA requirements. By encapsulating PHI with its access and usage policies, the DAC may enforce strict controls on who can access the information and under what conditions, addressing HIPAA's requirements for safeguarding patient data. Additionally, the real-time permission model of the DAC may allow for immediate revocation of access in the event of a policy violation, further securing PHI against unauthorized use and disclosure.

As such, the DAC may provide a comprehensive framework that not only meets but exceeds the privacy and security standards set by regulations like GDPR, CCPA, and HIPAA. The management of content provided by the DAC may offer a forward-thinking solution to the complex challenges of data protection compliance, promising a more secure and privacy-centric digital landscape.

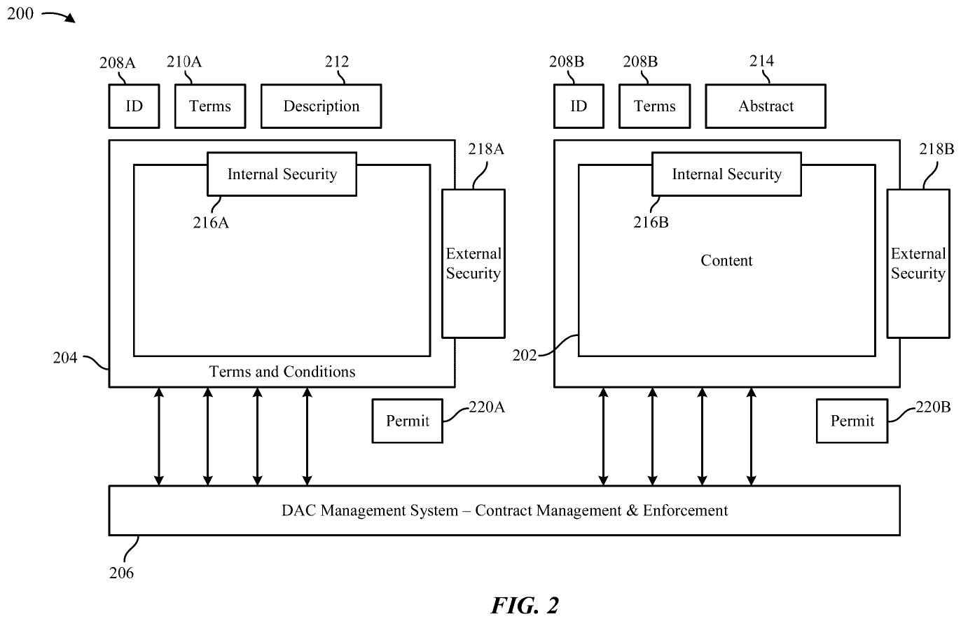

FIG. 2 depicts an example system 200 for encapsulating content with defined governing logic for the content in accordance with aspects of the present disclosure. For example, the system 200 may represent a DAC (e.g., a self-contained unit) as described herein, where the DAC is configured to bind a content 202 with governing logic 204 defined for the content 202 (e.g., terms and conditions for accessing, using, and/or sharing the content 202) into a single self-contained unit. The system 200 may include a DAC management system 206. In some aspects, the DAC management system 206 may manage one or more DACs (e.g., for one content owner and/or across multiple content owners) and enforce compliance of accessing, using, and/or sharing content in the one or more DACs according to the governing logic defined for each DAC.

In some aspects, the content 202 and the governing logic 204 may include and/or may be linked to an identifier (ID) 208 and terms 210. For example, the ID 208 may be an ID configured by and/or assigned to an owner of the content 202 (e.g., the content owner). The terms 210 may include general terms that apply to a plurality of content of the content owner. In some aspects, the governing logic 204 may include and/or may be linked to a description 212 (e.g., provided by the content owner) that describes what is covered by the governing logic 204. In some aspects, the content 202 may include and/or may be linked to an abstract 214 that briefly describes the content 202.

In some aspects, the content 202 may include different types of digital content. For example, the content 202 may include multimedia files (e.g., where the DAC can protect artistic works, promotional materials, and personal media from unauthorized access and alterations), textual content (e.g., where the DAC can ensure that textual representations of an individual or brand are distributed and used according to specified governance policies), software and/or code (e.g., where the DAC can potentially encapsulate software binaries or source code to protect intellectual property and ensure software distribution complies with licensing terms), or another type of digital content not explicitly listed herein.

In some aspects, the multimedia files may include visual content (e.g., images, photographs, infographics, visual data representations, branding materials, logos, trademarks, etc.), audio content or files (e.g., music tracks, albums, podcast episodes, audio clips for use in multimedia presentations or as standalone content, etc.), and/or video content (e.g., promotional videos, advertisements, trailers, educational videos, instructional videos, behind-the-scenes footage, interviews, documentary content, etc.). Additionally or alternatively, the textual content may include documents (e.g., articles, blog posts, press releases, eBooks, reports, white papers, scripts for speeches, scripts for presentations, scripts for video content, etc.) and/or social media content (e.g., posts, stories, social media campaigns, social media advertisements, updates intended for social media platforms, such as Instagram, Facebook, and LinkedIn, etc.).

Additionally or alternatively, the software and/or code may include interactive content (e.g., web applications and tools, games and interactive experiences, virtual reality (VR) and augmented reality (AR) content, etc.), software and applications (e.g., mobile applications, desktop applications, firmware and embedded systems, etc.), digital documents (e.g., contracts, agreements, licensing documents, instruction manuals and guidelines, research papers and academic articles, etc.), datasets (e.g., research data, customer data with appropriate privacy measures, financial data and reports, etc.), and/or web content (e.g., entire websites, specific web pages, webinar recordings, online course materials, etc.).

In some aspects, the content 202 may also include functions and/or artificial intelligence (AI)/machine learning (ML) operational elements. For example, the DAC may encapsulate trained ML models, including their parameters and the data they were trained on, which may allow for the secure sharing and deployment of AI models, ensuring that the model's integrity is preserved and that the model is used in accordance with specified governance policies. Additionally or alternatively, content generated by AI (e.g., such as articles, music, or art) may also be included within a DAC, which may ensure that AI-generated works are attributed correctly and used under the terms of the creator to address copyright and usage rights in the AI era. Additionally or alternatively, the DAC may encapsulate functions (e.g., especially those used in serverless architectures or cloud-based services) to enable secure and controlled execution of code snippets, which may be particularly useful for deploying AI or data processing algorithms with defined usage restrictions. Additionally or alternatively, incorporating executable code or functions within a DAC may open up possibilities for distributing software or algorithms with embedded usage policies, which may be useful for sharing proprietary algorithms under specific conditions or for academic purposes where research methods must be shared securely. Additionally or alternatively, the DAC may encapsulate AI models to enable sharing and using ML models to allow creators to specify how their models can be utilized, which may ensure that users adhere to ethical guidelines and usage terms and acknowledge the creators appropriately.

Additionally or alternatively, the DAC may encapsulate datasets (e.g., which may be crucial for AI and ML) to secure the data and control its usage, which may be important for sensitive or proprietary data used to train ML models, ensuring that data privacy and proprietary rights are maintained. Additionally or alternatively, the DAC may encapsulate ML operations components (e.g., training pipelines, model evaluation tools, and deployment mechanisms) that standardize, define, and/or secure a lifecycle of an ML model, such that creators of the ML models can enforce governance over how their AI solutions and/or ML models are deployed, scaled, and maintained. Additionally or alternatively, the experiences and environments created using VR and AR technologies may be encapsulated in DACs to ensure that immersive content is used and distributed according to the creator's intentions, preserving the authenticity of virtual experiences. Additionally or alternatively, while DACs may function independently of blockchain technology, encapsulating blockchain smart contracts within DACs may offer ways to automate and securely enforce content usage rights and transactions.

The architecture for the DAC may include an integration of several key technologies and principles to ensure that the DAC delivers secure, controlled, and compliant management of content. At its core, the DAC architecture may be built upon the principles of data encapsulation, advanced encryption, dynamic permissions, and secure communication protocols and may be structured to support scalability, flexibility, and interoperability across diverse digital ecosystems. For example, the DAC may offer a versatile and flexible approach to encapsulating content, allowing for the portability of the DAC across different platforms and environments without compromising the integrity of the governance policies (e.g., the governing logic 204). This means that regardless of where the DAC is stored or how the DAC is accessed, the governance policies may remain active and enforceable, ensuring continuous compliance and control.

In some aspects, this architecture may be particularly advantageous in distributed digital ecosystems, where content often traverses multiple environments and systems. The use of containerization may ensure that the governing logic 204 of the DAC (e.g., the DAC's governance policies) are always in effect, providing a consistent layer of security and control that travels with the content 202, thereby significantly reducing the risk of policy violation or data misuse.

In some aspects, the DAC architecture may include a secure data encapsulation layer for encapsulating the content 202. For example, the secure data encapsulation layer may tightly couple the content 202 with the governing logic 204 (e.g., associated governance policies and/or terms and conditions, including usage rules, lifecycle management instructions, and contractual terms). Each DAC may use advanced containerization technologies to generate a self-contained unit with embedded governance logic (e.g., the governing logic 204) that dictates how the content 202 can be accessed, shared, and used. This encapsulation ensures that governance policies are inseparable from the data, thus enforcing compliance and control directly at the data level. For example, the secure data encapsulation layer may be a framework designed to merge the content 202 with its governing logic 204 seamlessly.

This integration of the content 202 and the governing logic 204 may be achieved through the use of advanced encapsulation technologies, which enable the DAC to function as a self-contained unit. Within each DAC, the content 202 is not simply stored; the content 202 may be interwoven with embedded governance logic (e.g., the governing logic 204) that comprehensively outlines the conditions under which the content 202 can be accessed, shared, and utilized. This embedded governance logic may include detailed usage rules, lifecycle management instructions, and contractual terms tailored to specifications of an owner or agent of the content 202. By binding these policies directly with the content 202, the secure data encapsulation layer may ensure that any interaction with the content 202 (e.g., access, sharing, utilization, etc.) can only occur within the parameters set by the governing logic 204 (e.g., the embedded rules), thus maintaining strict compliance and control at the data level.

The secure data encapsulation layer may employ encapsulation technologies for isolating the content 202 and embedding the governing logic 204 into the content 202, itself. For example, the DAC may encapsulate digital content (e.g., documents, images, videos, artificial intelligence (AI) models, etc.) with its governance policies, binding the content 202 with its usage rules, lifecycle management instructions, and contractual terms. This encapsulation may create a secure and self-governing unit (e.g., self-contained unit) that enforces the governing logic 204 (e.g., defined by the content owner) directly at the data level (e.g., that goes beyond mere encryption or access control lists).

The secure data encapsulation technologies employed for generating a DAC may share some underlying principles (e.g., isolating resources and providing a defined execution environment) with traditional containerization or virtualization technologies, such as hypervisors, VMs (Virtual Machines), and Docker containers. However, DAC encapsulation may significantly differ in its purpose, functionality, and the problems it aims to solve, particularly in the realm of digital asset management and security.

For example, the principles shared by the secure data encapsulation technologies employed for generating a DAC and traditional containerization or virtualization technologies may include both DACs and traditional technologies (e.g., Docker or VMs) provide a form of isolation. For VMs and containers, the isolation may occur at the system or application level, separating different computing environments within a same physical infrastructure, and DACs may isolate digital content and its governance policies, creating a secure, self-contained unit. Additionally, like traditional technologies (e.g., Docker containers, which are known for their portability across different computing environments), DACs may encapsulate digital content and policies in a way that can be transported and recognized across various platforms, maintaining its integrity and the enforcement of its associated rules.

However, the secure data encapsulation technologies employed for generating a DAC may differ from the traditional containerization or virtualization technologies. For example, traditional containerization and virtualization technologies are primarily focused on isolating computing environments to improve deployment efficiency, scalability, and resource utilization. That is, traditional containerization or virtualization technologies may serve infrastructure and development operational needs. On the other hand, DAC encapsulation may be focused on securing digital content (e.g., documents, media files, AI models, etc.) and ensuring that its use complies with predefined governance policies. That is, DAC encapsulation may focus more on content management and security, rather than computing resource optimization.

Additionally or alternatively, DACs may uniquely bind digital content with its governance policies, enabling direct enforcement of usage rules, access controls, and lifecycle management instructions at the data level. This may include capabilities for real-time policy adjustment, monitoring, and compliance verification, which are not inherent to containerization or virtualization technologies. For example, VMs, hypervisors, and containers lack built-in mechanisms for governing how contained applications or systems interact with digital content from a legal or compliance standpoint. Additionally or alternatively, while VMs, hypervisors, and containers include security features aimed at protecting the computing environment and ensuring the safe execution of code, DACs may incorporate advanced encryption (e.g., including homomorphic encryption), digital signatures, and potentially blockchain technologies for content integrity verification and provenance tracking. These features may focus on securing the content itself and ensuring adherence to governance policies.

Additionally or alternatively, DAC encapsulation may be content-centric from creation to distribution and use (e.g., designed specifically to protect and manage digital assets throughout their lifecycle). On the other hand, traditional containerization and virtualization solutions are infrastructure-centric, aiming to abstract, optimize, and manage computing resources such as CPU, memory, and storage for applications. Additionally or alternatively, DACs may integrate AI and machine learning for real-time content monitoring, unauthorized alteration detection, and predictive analytics regarding brand impact, where this level of content-focused intelligence may be beyond the scope of traditional containerization or virtualization technologies.

At the core of the secure data encapsulation layer for the DAC is enforcing compliance and control directly at the data level. This approach may represent a paradigm shift in data management, where traditional systems typically apply governance mechanisms at the system or platform level, often leading to gaps in enforcement and inconsistencies in policy application. By integrating the governance policies (e.g., the governing logic 204) within the content 202 itself, the DAC may ensure that these governance policies are omnipresent, automatically enforcing compliance regardless of a location of the content 202 or the system on which the content 202 resides. This integration may streamline the enforcement of data governance and may also empower content owners with unprecedented control over their content (e.g., data assets). The embedded governance logic within each DAC may act as a guardian of the data owner's interests, ensuring that the use of the content 202 aligns with the owner's intentions.

In some aspects, the encapsulation technology implemented for the DACs may support dynamic access control, which may allow content owners to modify access rights and governance policies in real-time based on specific conditions and/or user behaviors. This flexible and autonomous control mechanism may enable adaptations to changing contexts and user interactions without compromising security or governance. Additionally, the DAC may integrate AI and/or ML to allow for advanced content analysis, usage monitoring, and predictive modeling regarding distribution and impact (e.g., of the DAC and/or the content 202). This capability may enable the DAC to learn from interactions and adapt its governance mechanisms accordingly for digital asset management.

The DAC architecture may further include distinct separation and encryption of a data contracts layer (e.g., for the content 202) and a data access layer (e.g., for the governing logic 204), each requiring independent decryption and authorization processes for access to a DAC. This dual-layer encryption strategy may strengthen the security posture of the DAC by adding an additional layer of protection and may also delineate the governing logic 204 or governance (e.g., contract) from the content 202 or actual usage of the content 202 (e.g., access), ensuring that each can be managed and secured according to its specific needs and sensitivities. The separation may allow for a granular control over access, where permissions can be precisely tailored and adjusted for the contract terms (e.g., the governing logic 204) independently of the content 202 itself.

The cryptographic linkage between these two layers may be designed using the ID 208 (e.g., corresponding to the content owner or content agent) and elements of the content 202 and/or the governing logic 204 to generate a unique hash, which in turn produces a distinct key for each layer for every aspect of the content 202 within the DAC. This method of generating unique keys based on the content 202 and its governance policies (e.g., the governing logic 204) may ensure that the encryption is robust and also personalized to a specific data item and its associated terms. This unique cryptographic binding may serve multiple purposes. For example, the cryptographic binding may reinforce the integrity of the content 202 and its governing logic 204 by ensuring that any attempt to tamper with either layer can be immediately detected and invalidated. Additionally, the cryptographic binding may facilitate a streamlined verification process for accessing the content 202, as the unique hash key ties the authorization directly to the specific conditions set by the content owner.

Accordingly, encryption and cryptographic services may form a next layer of the DAC architecture. Every piece of data within a DAC is encrypted using state-of-the-art cryptographic algorithms for an internal security 216, ensuring that the governing logic 204 remains confidential and tamper-proof (e.g., via an internal security 216A) as well as ensuring the content 202 remains confidential and tamper-proof (e.g., via an internal security 216B). This layer also employs digital signatures to maintain the integrity of the data and its associated governance policies, facilitating secure and verifiable transactions. For example, each DAC may include digital signatures and may potentially leverage blockchain or blockchain-like technologies for immutable provenance tracking. The digital signatures and immutable provenance tracking may ensure authentication of the content 202 and its source and may ensure that any alterations to the digital asset (e.g., the content 202 and/or the governing logic 204) can be detected, offering integrity verification and content authentication. Additionally, the DAC may incorporate quantum-resistant encryption algorithms to future-proof digital assets against potential quantum decryption threats.

By employing state-of-the-art cryptographic algorithms, each piece of content within a DAC may also be encrypted for an external security 218, rendering the content 202 confidential and secure from potential breaches. For example, the governing logic 204 may be encrypted for an external security 218A, and the content 202 may be encrypted for an external security 218B. This encryption may ensure that even if the content 202 were to be intercepted or accessed without permission, the content 202 would remain indecipherable and useless to the attacker because the attacker does not possess the permission to gain access to a permission signal 220 that is necessary to gain access of the content 202 from the content owner (e.g., a permission signal 220A for the governing logic 204 and a permission signal 220B for the content 202, or a single permission signal for both the governing logic 204 and the content 202). Additionally, this layer may utilize digital signatures, a critical component in maintaining the integrity of both the data and its embedded governance policies (e.g., for the internal security 216 and/or the external security 218). Digital signatures may provide a means for secure and verifiable transactions, enabling content recipients (e.g., users) to confirm the authenticity of the content 202 and ensuring that the content 202 has not been altered in transit. This dual approach of encryption and digital signature deployment may fortify the DAC against both external breaches (e.g., via the external security 218) and internal misuse (e.g., via the internal security 216), establishing a secure foundation for data handling and exchange.

In some aspects, the layer for encryption and cryptographic services may incorporate and/or use homomorphic encryption (e.g., partially homomorphic encryption (PHE), somewhat homomorphic encryption (SHE), fully homomorphic encryption (FHE), levelled homomorphic encryption (LHE)) to enhance the utility and security of the DAC. Homomorphic encryption may include cryptographic techniques that allow for computations to be performed on encrypted data (e.g., the content 202), without needing to decrypt the encrypted data first. This capability may be transformative to enable the DAC to support secure data processing and analysis in encrypted form, thereby maintaining privacy and confidentiality of the content 202 even during use. The inclusion of homomorphic encryption may broaden the applicability of the DAC in sensitive fields such as healthcare and finance, where data and/or content can be analyzed and utilized without exposing the underlying sensitive information. Further, homomorphic encryption may underpin the data sovereignty and control in the DAC, as homomorphic encryption may ensure that the content 202 remains encrypted and protected throughout its lifecycle, even when being actively processed. Using homomorphic encryption may elevate the security measures within the DAC architecture and may also open avenues for secure data utilization.

Additionally or alternatively, the layer for encryption and cryptographic services may incorporate and/or use other encryption algorithms. For example, the other encryption algorithms may include a multi-party computation (MPC) algorithm, an advanced encryption standard (AES) algorithm, a triple data encryption standard (DES) algorithm, Rivest-Shamir-Adleman (RSA) algorithm, Elliptic Curve Cryptography (ECC), ChaCha20, Twofish, Quantum Key Distribution (QKD), Post-Quantum Cryptography Algorithms, Secure Hash Algorithm 3 (SHA-3), Blowfish, Camellia, CAST-128/CAST5, CAST-256/CAST6, Serpent, International Data Encryption Algorithm (IDEA), Threefish, McEliece Cryptosystem, NewHope, or another encryption algorithm not expressly listed herein. Additionally or alternatively, the layer for encryption and cryptographic services may incorporate and/or use other technologies similar to homomorphic encryption or in addition to homomorphic encryption, such as bootstrapping, noise growth, MPC, etc.

In some aspects, the DAC architecture may include a dynamic permissions model. For example, the dynamic permissions model may include and/or use cryptographic techniques to generate and manage a periodic refresh of permit signals (e.g., the permission signal(s) 220). The dynamic permissions model may include a secure handshake mechanism between a system of a user (e.g., accessing, utilizing, and/or sharing a DAC) and a system of the content owner or content agent, where the handshake mechanism is configured to validate compliance with the agreed-upon terms and conditions (e.g., the governing logic 204). In case of non-compliance or a breach of contract, the architecture (e.g., via the dynamic permissions model) may automatically revoke the permit signal, leveraging cryptographic protocols to transition the content 202 and/or DAC into a deny state.

The dynamic permissions model within the DAC architecture may introduce a mechanism for managing data access rights, underpinned by robust cryptographic techniques. For example, the techniques and mechanisms of the dynamic permissions model may be instrumental in generating and managing the periodic refresh of permit signals, which may be a core component that enables real-time (e.g., near real-time, periodic, on request, push-pull, etc.) governance over access to the content 202. As described previously, this process may be facilitated through a secure handshake mechanism between the system of the user and the system of the content owner or content agent, ensuring that access to the content 202 is contingent upon continuous validation of compliance with the established terms and conditions (e.g., the governing logic 204). In instances where compliance is not met or a breach of contract occurs, the dynamic permissions model and/or DAC architecture may be designed to automatically revoke the permit signal. This revocation may be executed using cryptographic protocols, which may effectively transition the content 202 and/or DAC back into its natural deny state, preventing any unauthorized access or use. The dynamic permissions model may reinforce the security of data transactions and may ensure that governance of the content 202 is dynamically aligned with stipulations from the content owner, offering a flexible yet secure approach to data access management.

In some aspects, the dynamic permissions model may incorporate homomorphic encryption (e.g., partial homomorphic encryption, FHE, etc.), as described previously, to further enhance its capabilities by allowing computations to be performed on encrypted data without decrypting the encrypted data. For example, the validation of compliance, the refreshing of permit signals, and the enforcement of access controls may be conducted on content 202 that remains in its encrypted state, thereby offering an additional layer of security. The use of homomorphic encryption in this context may provide the DAC architecture by ensuring that data privacy is maintained even during the process of access control and compliance checks. Additionally, homomorphic encryption may facilitate a higher level of data utility while still adhering to strict privacy standards, as homomorphic encryption may allow for meaningful operations on encrypted data. This integration of homomorphic encryption into the dynamic permissions model of the DAC may fortify the architecture against potential security breaches and may also maximize the utility of encrypted data, ensuring that the DAC architecture remains at the forefront of privacy-preserving technologies in data management. Additionally or alternatively, the dynamic permissions model may incorporate one or more other encryption algorithms as provided previously.

In some aspects, the DAC may include a communication layer. At the communication layer, secure channels may facilitate the exchange of compliance reports and permit signal refresh requests between the systems of the user(s) and the content owner(s). For example, the communication layer may use secure communication protocols, such as Transport Layer Security (TLS), to ensure that all data transmissions are encrypted and authenticated. Additionally, the communication layer may be responsible for the real-time (e.g., near real-time, periodic, on request, push-pull, etc.) monitoring and management of access permissions based on the continuous assessment of compliance status.

In some aspects, the described DAC architecture may support interoperability through application programming interface (API) gateways or blockchain-based smart contracts (as needed), enabling seamless integration with existing systems and platforms while ensuring the secure and efficient exchange of information. For example, the DACs may be communicated across, integrated with, and/or interfaced through one or more external systems, such as a publishing and subscribing (PubSub) system, RESTful APIs, GraphQL, WebSocket, Server-Sent Events (SSE), SOAP, MQTT, AMQP, gRPC, a really simple syndication (RSS)/Atom Feeds, Webhooks, Odata, CoAP, JSON-RPC, XML-RPC, STOMP, SignalR, Apache Kafka, RSocket, ZeroMQ, or another external system not expressly listed herein.

Additionally or alternatively, for the described DAC architecture, the DACs may be communicated across, integrated with, and/or interfaced though quantum-secured communication channels, quantum computing APIs, adaptive AI interfaces, AI-generated content distribution, autonomous edge computing interfaces, natural language processing (NLP) enhanced interfaces, neural interface technology, AI-driven predictive analytics interfaces, quantum-enhanced optimization for real-time systems, self-learning systems, biometric interaction interfaces, emotional recognition and response systems, holographic projection interfaces, blockchain-based identity and transaction platforms, AR workspaces and environments, voice-activated and conversational AI platforms, VR engagement spaces, quantum communication networks, digital olfaction and taste interfaces, neuro-interactive interfaces, AI-driven predictive modeling interfaces, smart environment integration, intent-recognition systems, predictive analytics interfaces, emotionally intelligent interfaces, autonomous agent interfaces, AR guidance systems, quantum- assisted forecasting interfaces, or another interface not expressly listed herein.

By leveraging secure communication protocols such as TLS, the communication layer may ensure that all data transmission (e.g., including compliance reports and permit signal refresh requests) are encrypted and authenticated, safeguarding the information from interception or tampering during transit. The emphasis on secure channels may be crucial for the real-time monitoring and management of access permissions, which rely on the continuous assessment of compliance status to determine the validity of data access. This architecture may facilitate a robust defense against potential cyber threats and may also support the dynamic nature of permission control within the DAC framework, allowing for immediate adjustments to access rights in response to compliance changes.

Additionally or alternatively, the communication layer may leverage other secure communication protocols, such as Hypertext Transfer Protocol Secure (HTTPS), secure sockets layer (SSL)/TLS, Secure Shell Protocol (SSH), internet protocol security (IPsec), datagram TLS (DTLS), Wi-Fi Protected Access 3 (WPA3), Secure/Multipurpose internet Mail Extensions (S/MIME), Open Pretty Good Privacy (OpenPGP), Signal Protocol, OAuth 2.0, Quick User Datagram Protocol (UDP) Internet Connections (QUIC), WireGuard, Kerberos, Secure Real-time Transport Protocol (SRTP), Lightweight Directory Access Protocol (LDAP) over SSL (LDAPS), Simple Network Management Protocol version 3 (SNMPv3), Secure Copy Protocol (SCP), Pretty Good Privacy (PGP), Internet Key Exchange version 2 (IKEv2), or another secure communication protocol not expressly listed herein.

Additionally or alternatively, the communication layer may implement and/or leverage other secure communication protocols, such as quantum encryption, post-quantum cryptography (PQC), AI-optimized encryption algorithms, intelligent threat detection and response, automated security policy management, secure (SMPC) protocols, quantum-resistant authentication, energy-efficient cryptography, dynamic biometric verification protocols, context-aware security protocols, decentralized identity and authentication protocols (DIAP), quantum-enhanced secure channel protocols (QESCP), AI-managed encryption protocols (AIMEP), homomorphic encryption protocols, zero-knowledge proof protocols, federated learning security protocols, SMPC enhanced protocols, intelligent anomaly detection systems (IADS), adaptive security protocols, predictive threat detection protocols, behavioral biometrics authentication, quantum-resilient cryptography, AI-driven encryption key management, self-healing networks, zero-knowledge proofs for privacy preservation, SMPC for collaborative security, context-aware access control, intelligent anomaly and intrusion detection systems (IDS), or another secure communication protocol.

In some aspects, the secure communication described herein may occur at a Layer 2 (e.g., data link layer) and/or a Layer 2.5 (e.g., considered as part of network protocols that do not fit neatly into traditional open systems interconnection (OSI) model layers, such as multiprotocol label switching (MPLS)) of the OSI model. Secure communications on the Layer 2 and/or Layer 2.5 of the OSI model may protect the content 202 and/or DAC as the content 202 and/or DAC traverse local networks or are transported across different segments of a network infrastructure. Protocols and mechanisms designed for these layers may provide security features such as encryption, integrity checks, and secure authentication directly on the network hardware or at the link level between devices. For example, these protocols and mechanisms may include a medium access control security (MACsec) protocol (e.g., defined in Institute of Electrical and Electronics Engineers (IEEE) standard 802.1AE), Link Layer Discovery Protocol-Media Endpoint Discovery (LLDP-MED), IEEE standard 802.1X, MPLS, secure virtual local area networks (VLANs), virtual private wire service (VPWS), virtual private local area network (LAN) service (VPLS), QKD for Layer 2 networks, Layer 2 tunnels with encryption, protected extensible authentication protocol (PEAP), or another protocol or mechanism not listed herein.

In some aspects, the communication layer may integrate homomorphic encryption (e.g., PHE, SHE, FHE, LHE, etc.) may further elevate security capabilities of the communication layer by enabling operations on encrypted data without the need for decryption. The application of homomorphic encryption at the communication layer may correspond to compliance checks and permit signal refresh processes that could be performed while the data remains encrypted, thus eliminating exposure risks associated with data decryption during transmission or processing. Homomorphic encryption may be particularly advantageous in scenarios where highly sensitive data is involved, as homomorphic encryption minimizes vulnerability of the content 202 at every stage of the communication process. Further, the use of homomorphic encryption may enhance the privacy-preserving aspects of the DAC, allowing for the secure exchange of information and access permissions without compromising the confidentiality of the underlying data. Additionally or alternatively, the communication layer may incorporate one or more other encryption algorithms as provided previously.

In the preceding description, the real-time communication described may include and/or implement real-time timing, near real-time timing, periodic timing, event- triggered timing, periodic timing, event-triggered timing, cyclical timing, batch processing timing, synchronous timing, asynchronous timing, time-bound timing, stream processing timing, latency-sensitive timing, time-sensitive networking, time division multiplexing, concurrency timing, scalability timing, reliability timing, security timing, data consistency timing, performance timing, interoperability timing, maintainability timing, cost timing, regulatory compliance timing, hybrid timing, or another timing not expressly listed herein.

Additionally or alternatively, access timing (e.g., in the context of data access and communication systems) may determine a responsiveness and efficiency of services and application. When discussing how the content owner and the content recipient (e.g., user) engage, one or more access timing factors may be considered. For example, the access timing factors may include batch processing, on-demand access, scheduled access, event- driven access, stream processing, asynchronous access, synchronous access, lazy loading, preemptive access, interactive access, or other factors not expressly listed herein.

In some aspects, every DAC that is generated may incorporate a digital identity (e.g., ID assigned by the content owner and/or an ID created by a DAC management system that corresponds to the content owner). The digital identify may be used to identify the agent or owner of the content that is protected inside the DAC, which may represent an improvement over traditional IAM systems. For example, this improvement may be primarily characterized by the integration of content governance directly with digital identity, enhancing content security, provenance, and compliance management in a unified manner. By embedding a digital identity within each DAC, a clear and immutable linkage may be formed between the digital content and its owner or responsible agent. This connection may ensure a higher level of content provenance and integrity, as every piece of content can be directly traced back to its source. Unlike traditional IAM (e.g., which focuses on securing access to systems and resources without necessarily linking content to its creator), the DAC approach may ensure that the origins, authenticity, and integrity of content are verifiable, providing a robust framework for managing digital rights and ownership.

Additionally or alternatively, the DAC model may integrate governance policies and digital identity within the same encapsulation, offering a unified approach to content management. This integration may allow for the enforcement of usage rules, access controls, and distribution policies directly linked to the content's identity, streamlining compliance and governance processes. In contrast, IAM systems typically manage user identities and access separately from content governance, requiring additional layers of integration to associate content with specific policies or owners. With each DAC having a digital identity tied to specific governance policies, the system may automatically enforce compliance with these policies across different platforms and use cases. This capability may represent a significant advancement over traditional IAM systems, where policy enforcement may require manual intervention or complex configuration.

Additionally, the DAC may ensure that content usage always adheres to the owner's terms, regardless of where or how the content is accessed, enhancing the scalability and effectiveness of digital asset management. In some aspects, incorporating digital identities into DACs may enable proactive security measures tailored to the content level, including advanced encryption, digital signatures, and potentially quantum-resistant algorithms. These measures may go beyond the scope of traditional IAM by protecting the content itself, not just the systems or platforms where the content resides. This content-centric security model may address the evolving threats in the digital landscape, offering a more comprehensive protection mechanism for digital assets.

Additionally, the DAC model may facilitate decentralized verification of content ownership and authenticity without relying on centralized authorities or systems. This approach may contrast with traditional IAM systems that often depend on centralized directories or authentication services. By enabling decentralized verification, the DAC may enhance privacy, reduce reliance on single points of failure, and support a more distributed and resilient digital ecosystem. In essence, the DAC's incorporation of digital identity directly with content governance and security may represent a forward-thinking improvement over traditional IAM solutions.

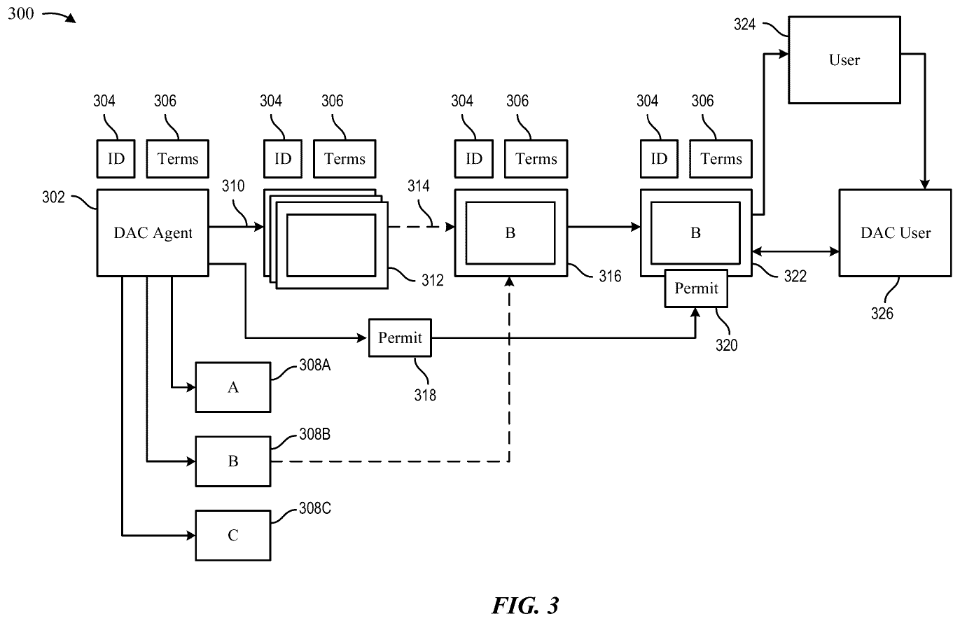

FIG. 3 depicts an example process 300 for creating a DAC for encapsulating content with defined governing logic for the content in accordance with aspects of the present disclosure. As described herein, the process 300 may provide a systematic approach by which a DAC agent 302 (e.g., content agent or content owner) creates a DAC that involves several key steps, ensuring that the content is securely encapsulated along with its governance policies. In some aspects, the process 300 may emphasize security and privacy of the content and also emphasize autonomy and control the content owner has over their content (e.g., data assets).

An initial step of the process 300 may include the DAC agent 302 specifying content that needs to be encapsulated within a DAC (e.g., content that the content owner wants to protect). For example, the DAC agent 302 may own or manage different types of content 308, such as a first content 308A, a second content 308B, and a third content 308C, and may specify each of the contents 308 to be encapsulated into one or more DACs. In some aspects, the DAC agent 302 may create an ID 304 for the DAC(s). Alongside the content, the DAC agent 302 may define governance policies 306 (e.g., terms and conditions for accessing the DAC and/or content), which may include usage rules, lifecycle management instructions, and contractual terms. In some aspects, the governance policies 306 may dictate how the specified content can be accessed, shared, and utilized, ensuring that any use of the specified content aligns with intentions of the DAC agent 302.

Subsequently, the DAC agent 302 may begin a DAC creation 310. For example, the DAC creation 310 may include creating one or more DACs 312. In some aspects, as part of the DAC creation 310, once the contents 308 and the governance policies 306 are defined, a next step of the process 300 may include encrypting the contents 308 using advanced cryptographic algorithms (e.g., as described with reference to FIG. 2) to ensure confidentiality and integrity of the contents 308. This encryption step may render the contents 308 tamper-proof and may secure the contents 308 from unauthorized access. Additionally, the governance policies 306 may be cryptographically signed to maintain their integrity and to facilitate secure and verifiable transactions. This cryptographic signature may ensure that the governance policies 306, themselves, cannot be altered without detection.

Following encryption and signing, the process 300 may include a containerization 314 (e.g., DAC wrap) to encapsulate the contents 308 and the governance policies 306 using containerization technologies (e.g., as described with reference to FIG. 2). In some aspects, when a content 308 is ready, the DAC agent 302 may put the content 308 into a DAC. For example, in the example of FIG. 3, the containerization 314 may involve packaging the second content 308B with the governance logic 308 into a DAC 316 (e.g., a self-contained unit or “capsule”). This encapsulation process may bind the second content 308B with its governance policies 306, making the second content 308B and the governance policies 306 inseparable and enforcing compliance of the governance policies 306 directly at the data level. The use of containerization technology may allow for the DAC 316 to be portable and operable across different platforms and environments (e.g., as described with reference to FIG. 2) without compromising on security or integrity.

In some aspects, to further enhance security, unique cryptographic keys may be generated based on an ID of the DAC agent 302 (e.g., content owner/agent ID) and elements of the DAC 316 (e.g., the second content 308B and the governing policies 306). These keys may be used to separately encrypt a data contracts layer and a data access layer, ensuring that each layer requires separate decryption and authorization for access to the DAC 316 and/or the second content 308B. Additionally, secure communication channels may be established to facilitate the exchange of compliance reports and refresh requests of a permit signal 318, ensuring that all communications are encrypted and authenticated.

Subsequently, the DAC 316 may be ready for integration and deployment within a desired digital ecosystem. This integration and deployment may involve configuring access gateways (e.g., API gateways and/or gateways for integration into other external systems) for interoperability with existing systems or setting up blockchain-based smart contracts for automated enforcement of the governance policies 306. The DAC agent 302 may then deploy the DAC 316, making the DAC 316 available for access and use under the specified conditions. Throughout the process 300, an emphasis may be placed on securing the contents 308 and the governance policies 306, maintaining the integrity of the contents 308, and ensuring that the DAC agent 302 retains full control over how the contents 308 are used.

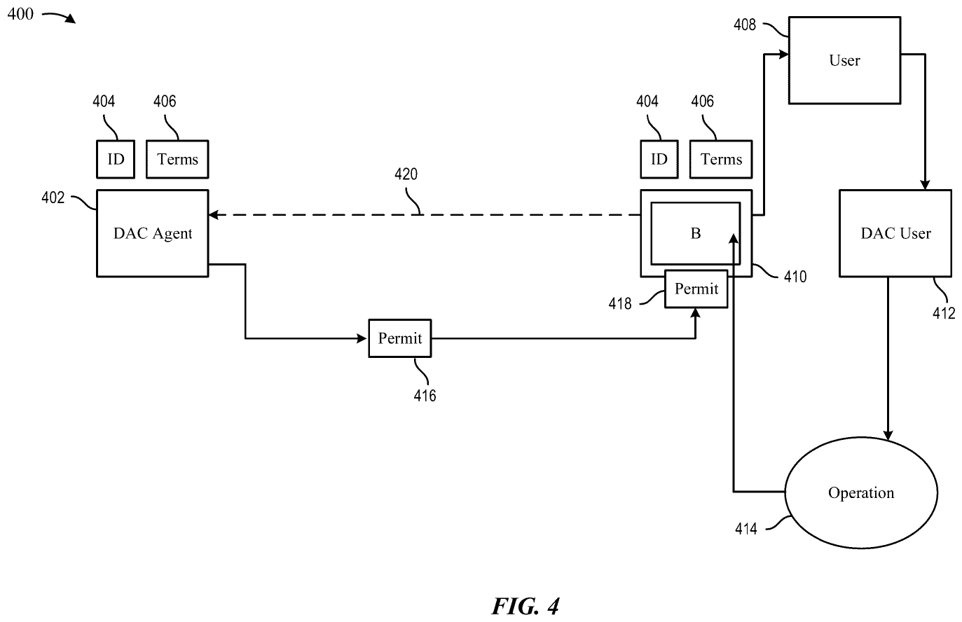

In some aspects, when sharing a content 308, the DAC agent 302 (e.g., content owner) may send a DAC 322 to a user 324. If the user 324 is not registered and/or validated to access DACs, the user 324 may become a DAC user 326 (e.g., which will be described in greater detail to reference FIG. 4). Subsequently, the DAC user 326 may be authorized to receive and/or access the DAC 322 based on receiving a permit signal 320, where the permit signal 320 enables the DAC user 326 to access the second content 308B in the DAC 322 according to the governing policies 306. In some aspects, a DAC management system for the DAC agent 302 may review DAC logging and reporting and may send permission (e.g., the permit signal 320) for the DAC 322 to permit the DAC user 326 to use and/or access the DAC 322 and the second content 308B.

FIG. 4 depicts an example process 400 for sending a DAC in accordance with aspects of the present disclosure. In some aspects, the process 400 may outline accessing content protected by a DAC using a comprehensive and secure method for data access and usage, ensuring that only authorized users can interact with the content under strict adherence to terms and conditions defined by an owner and/or agent for the content. For example, the process 400 may include a DAC agent 402 (e.g., content owner or content agent) sharing a DAC 410 (e.g., that includes an ID 404) for a user 408 to access, where the DAC 410 includes content bound to governance policies 406 (e.g., terms and conditions). In some aspects, the process 400 may include several critical steps that reinforce data security, privacy, and compliance from the moment the user 408 encounters a DAC-protected file (e.g., the DAC 410).

When a user receives DAC-enabled content, the user may engage in a secure and structured process (e.g., the process 400) designed to uphold the privacy, integrity, and the specific governance policies of content in the DAC 410 set by the DAC agent 402. This process may ensure that the content in the DAC 410 is accessed and used according to stipulations of the DAC agent 402, underpinned by robust security and compliance mechanisms.

In some aspects, the user 408 may attempt to open a file. For example, upon receiving a file with a regular extension indicating that the file is DAC protected, the user 408 may be informed of the DAC protection when attempting to open the file (e.g., the user 408 is notified the file is in a DAC, such as the DAC 410). That is, upon attempting to open a DAC-protected file, the user 408 may be informed that the file is secured by DAC technology. This notification may occur regardless of a standard extension for the file, indicating that while the file appears accessible, its contents are under DAC protection and require specific steps for access.

This initial interaction may trigger a sequence of actions required for secure data access. For example, if the user 408 is not yet registered as a DAC-validated user, the user 408 may be prompted to register and obtain a DAC user ID. Additionally, the user 408 may be instructed to install a DAC management system agent (e.g., on a device of the user 408). After registering, obtaining the DAC user ID, and installing and downloading the DAC management system agent, the user 408 may become a DAC user 412. These prerequisites to become a DAC-validated user (e.g., the DAC user 412) may ensure that potential users are vetted and authenticated, establishing a secure foundation for subsequent data access requests. Additionally, enforcing the potential users to become DAC-validated users may be critical for establishing a secure and authenticated environment, ensuring that only verified users can request access to DAC-protected data.

In some aspects, the user registration (e.g., the user 408 becoming the DAC user 412) may initiate a secure exchange between the DAC user 412 (e.g., a potential user) and the DAC agent 402 (e.g., content owner). For example, following user registration, a DAC management system agent may facilitate a secure handshake between the DAC user 412 and the DAC agent 402. The secure exchange may start with the identification of the DAC agent 402 using an ID of the DAC agent 402 and/or the ID of the DAC user 412. For example, the DAC user 412 may be prompted to correctly identify the DAC agent 402 (e.g., based on identifying the ID of the DAC agent 402). If correctly identified, the DAC management system agent may securely transmit an access request for the DAC 410 and/or the content within the DAC 410 from the DAC user 412 to the DAC agent 402. The DAC agent 402 may then review and/or evaluate this access request and may decide whether to grant access to the DAC user 412 based on credentials of the DAC user (e.g., the ID of the DAC user 412, corresponding credentials for the DAC user 412, etc.) and an intended use of the DAC 410 and/or the content within the DAC 410.

If the DAC agent 402 decides to grant access to the DAC user 412, a first layer of negotiation may begin, focusing on the data contract terms and conditions. That is, upon approval by the DAC agent 402, the process 400 may advance to negotiating the contract layer, which may include the terms and conditions of use for the DAC 410 and/or the content within the DAC 410. For example, the DAC user 412 may read these terms and conditions (e.g., governance policies 406, DAC terms, etc.), which outline how the DAC 410 and/or the content within the DAC 410 can be accessed, shared, and utilized. In some aspects, the DAC user 412 must agree to these terms and conditions in order to be able to access the DAC 410 and/or the content within the DAC 410. For example, this agreement may be essential for proceeding, as it sets the legal and operational framework for data access and usage and legally binds the DAC user 412 to adhere to the specified conditions, ensuring that data usage remains in compliance with the governance policies 406 set by the DAC agent 402.

Following the DAC user 412 accepting and/or agreeing to the terms and conditions, a system of the DAC user 412 may be configured to comply with the DAC access terms, including enabling mechanisms for compliance reporting. This step of configuring the system of the DAC user 412 may ensure that interactions of the DAC user 412 with respect to the DAC 410 and/or content in the DAC 410 will be continuously monitored and evaluated against the agreed-upon conditions (e.g., the governance policies 406 and/or terms and conditions).

With the contract layer terms agreed upon and the system of the DAC user 412 being prepared and/or configured for compliance, the negotiation may move to a second layer concerning data encryption. This second layer may involve cryptographic negotiations that enable the DAC user 412 to decrypt and access the content within the DAC 410 securely. For example, once the contract terms are agreed upon, the next step may involve negotiating the data encryption layer, which may establish the technical means of accessing the DAC-protected data securely for the DAC agent 412. The sequence of operations may be strict, underscoring the importance of establishing legal and operational compliance before any data access occurs.

In some aspects, a successful negotiation may result in the DAC management system agent of the DAC agent 402 configuring a permit signal 416 for the DAC 410 and the DAC user 412 receiving a permit signal 418 from the DAC agent 402, enabling access to the content in the DAC 410 under the agreed-upon terms. For example, upon successful negotiation of both layers, the DAC agent 402 may issue the permit signal 416 and/or permit signal 418, allowing the DAC user 412 to access the content of the DAC 410 according to the established agreement.

However, should the DAC user 412 fail to comply with logging or reporting requirements and/or if a breach of the contract terms is detected, the permit signal 418 may be withdrawn, and the DAC 410 may revert to a deny access state, effectively blocking the DAC user 412 from accessing the DAC 410 and/or the content within the DAC 410. For example, a compliance of the DAC user 412 with the DAC access terms and conditions (e.g., governance policies 406) may be continuously monitored while the DAC user 412 performs one or more operations 414 on the DAC 410 and/or on the content within the DAC 410. This continuous monitoring may include ensuring that the DAC user 412 adheres to the agreed usage policies when performing the one or more operations 414 and that the DAC user 412 participates in necessary compliance reporting. Accordingly, failure to comply with these terms and/or failure to provide required reports may result in the revocation of the permit signal 418, effectively returning the DAC 410 to a deny access state and blocking the DAC user 412 from further accessing the DAC 410 and/or the content within the DAC 410.

The process 400 described above may underscore a commitment of the DAC 410 to safeguarding privacy and security of content within the DAC 410 while enforcing the governance policies 406 as stipulated by the DAC agent 402 (e.g., content owner) for the DAC 410. By requiring user registration, facilitating secure negotiations, and continuously monitoring compliance, the DAC 410 may ensure that every access and use of the content is authorized, secure, and in strict adherence to the conditions defined and/or assigned by the DAC agent 402, maintaining the integrity and confidentiality of content within the DAC 410 throughout its lifecycle.

In some aspects, a DAC management interface may provide initial license verification via a feedback 420. Additionally, the DAC management interface may contact a DAC ID (e.g., the ID 404) for an open signal ready indication. In some aspects, the DAC user 412 may want to read content and/or a file in the DAC 410. Subsequently, a ‘read’ may occur, and the DAC management system may log the ‘read’ event (e.g., via the feedback 420). In some aspects, the DAC management system may then report on operations and adherence to license terms and conditions (e.g., via the feedback 420). In some aspects, the DAC management system for the DAC agent 402 may review DAC logging and reporting and may concur and/or agree with continuing access for the DAC user 412. Accordingly, the DAC management system may refresh the permit signal 416 and/or the permit signal 418 to continue access for the DAC user 412.

When a user receives DAC-enabled content with specific owner/agent restrictions on derivative materials, the process may unfold in a structured manner as described below to ensure that all interactions with the content comply with the established governance policies. This scenario may involve adherence to the DAC's embedded rules, especially concerning the creation and management of derivative works.

For example, when a user receives DAC-enabled content that comes with specific restrictions from the DAC owner or agent (e.g., content owner or content agent) regarding derivative materials (e.g., content derived from original content in a DAC), the user may enter into a regulated environment that meticulously controls how the content can be used, especially concerning the generation and handling of any derived works. This scenario may involve several key processes to ensure that the integrity, ownership rights, and governance provisions of the original content are upheld in any subsequent use or derivative creation.

Upon accessing the DAC-enabled content, the user may be notified and/or made aware of the conditions and restrictions imposed on derivative materials through the embedded governance policies (e.g., as stipulated by the DAC owner/agent). This notification may include details on the governance policies related to the creation, use, and sharing of any derivative content. For example, these policies may clearly outline what constitutes allowable use of the content and under what conditions derivative works may be created. In some aspects, these policies may specify that any derivative material generated from the original DAC-protected content must also be encapsulated within a new DAC, maintaining a direct link to the original DAC including all provenance details. This direct link may ensure a continuous chain of custody and adherence to the original terms set by the content owner or agent. The user must acknowledge these terms, indicating their understanding and agreement to comply as a prerequisite to accessing the original content.

The user may access the DAC-enabled content within the confines of the agreed-upon restrictions. As the user interacts with the content, any action that could lead to the creation of derivative materials may be governed by the DAC's embedded policies. These policies may dictate the conditions under which such materials can be produced, including requirements for securing permissions, reporting, and ensuring that any derivative work is also encapsulated within a new DAC.

If the user decides to create derivative material based on the DAC-protected content, the user must initiate the creation of a new DAC for encapsulating this derivative content. This new DAC may inherit the governance policies of the original DAC, possibly with additional restrictions as deemed necessary by the creator of the derivative material, provided that the additional restrictions do not contravene the original DAC's restrictions. That is, this new DAC may inherit the restrictions from the original DAC, including all provenance details and the same or more stringent contract provisions. In some aspects, the user may be responsible for ensuring that the new DAC is configured correctly to comply with these requirements.

Additionally, the new DAC must explicitly maintain the link to the original DAC, including provenance and contractual provisions, ensuring that the origins of the material and the conditions of its use are transparent and traceable. For example, the new DAC created for the derivative material may maintain a direct link back to the original DAC, preserving the chain of custody and provenance of the data. This linkage may be critical for transparency, allowing for the traceability of the data's origins and its journey through various transformations or analyses. Additionally, the linkage may ensure that the lineage of the derivative material is clear and that the original owner/agent's restrictions continue to be honored. This mechanism may protect the rights of the original data owner or agent and may also ensure that any value derived from the original content is managed in a manner that respects the original terms of use, including the secure, responsible handling of data and adherence to privacy and compliance standards. In some aspects,

Depending on the governance policies set by the original DAC owner/agent, the creation of derivative materials and their encapsulation within a new DAC may require a review and approval process. This process may allow the original owner/agent to assess the compliance of the new DAC with the established restrictions and to verify that the provenance and contractual obligations are accurately maintained. Once the new DAC is approved and in place, users can access and use the derivative materials within the confines of the new DAC's restrictions. Like with the original DAC, access may be contingent upon compliance with the governance policies, and continuous monitoring ensures adherence to the terms.

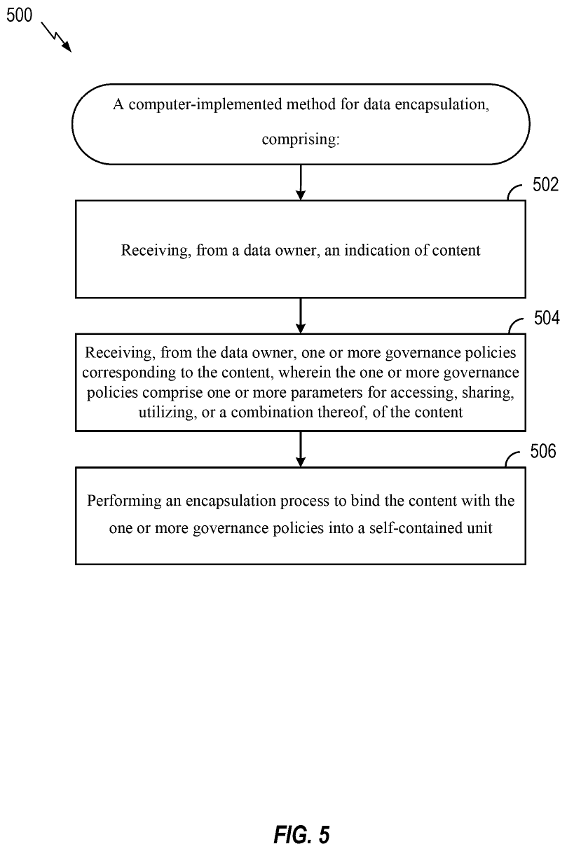

FIG. 5 depicts a method 500 for data encapsulation in accordance with aspects of the present disclosure. In some aspects, the method 500 may be performed by an apparatus, such as a user terminal, a database server, or a system containing multiple computing devices and/or a cloud client 102 as described with reference to FIG. 1 and/or another device.

Method 500 begins at block 502 with receiving, from a content owner, an indication of content.

Method 500 then proceeds to block 504 with receiving, from the content owner, one or more governance policies corresponding to the content, wherein the one or more governance polices comprise one or more parameters for accessing, sharing, utilizing, or a combination thereof, of the content.

Method 500 then proceeds to block 506 with performing an encapsulation process to bind the content with the one or more governance policies into a self-contained unit.

In certain aspects, method 500 further includes performing, prior to the encapsulation process, a first encryption process on the content.

In certain aspects, method 500 further includes performing, prior to the encapsulation process, a second encryption process on the one or more governance policies.

In certain aspects, the first encryption process and the second encryption process comprise an FHE algorithm or another encryption algorithm.

In certain aspects, method 500 further includes applying a cryptographic signature from the content owner to the one or more governance policies.

In certain aspects, the content is inseparable from the one or more governance policies in the self-contained unit based at least in part on performing the encapsulation process, and the one or more governance policies are enforced for the self-contained unit at a data level based at least in part on performing the encapsulation process.

In certain aspects, method 500 further includes generating one or more unique cryptographic keys for the self-contained unit, wherein the one or more unique cryptographic keys are generated based at least in part on an identifier corresponding to the content owner, the content in the self-contained unit, or a combination thereof.

In certain aspects, method 500 further includes performing, at a first layer, a first encryption process on a contract based at least in part on the one or more unique cryptographic keys, wherein the contract is configured to enforce the one or more governance polices.

In certain aspects, method 500 further includes performing, at a second layer, a second encryption process on an access agreement based at least in part on the one or more unique cryptographic keys, wherein the access agreement is configured to enable access to the self-contained unit.

In certain aspects, method 500 further includes establishing one or more communication channels via a secure communication protocol, wherein the one or more communication channels are configured for exchanging compliance and permission signaling to enable access to the self-contained unit.

In certain aspects, the secure communication protocol comprises a TLS protocol or another secure communication protocol.

In certain aspects, the method 500 further includes configuring one or more access gateways to integrate the self-contained unit with one or more external systems.

In certain aspects, the one or more external systems comprise an API system or another external system.

In certain aspects, the method 500 further includes designating the self-contained unit for deployment, wherein designating the self-contained unit for deployment comprises indicating the self-contained unit is available for access to a user according to the one or more governing policies.

In certain aspects, the method 500 further includes creating an identifier for the self-contained unit.

In certain aspects, the method 500 further includes receiving, from the content owner, an indication of the identifier for the self-contained unit.

In certain aspects, the one or more governing policies comprise license terms and conditions, usage rules, lifecycle management instructions, contractual terms, or a combination thereof for the self-contained unit.

In certain aspects, the method 500 further includes sending, to a user, the self-contained unit.

In certain aspects, the self-contained unit is sent via a secure communication protocol.

In certain aspects, the content comprises data and one or more functions for the data.

In certain aspects, the content comprises textual content, visual content, audio content, software, source code, or another type of content.

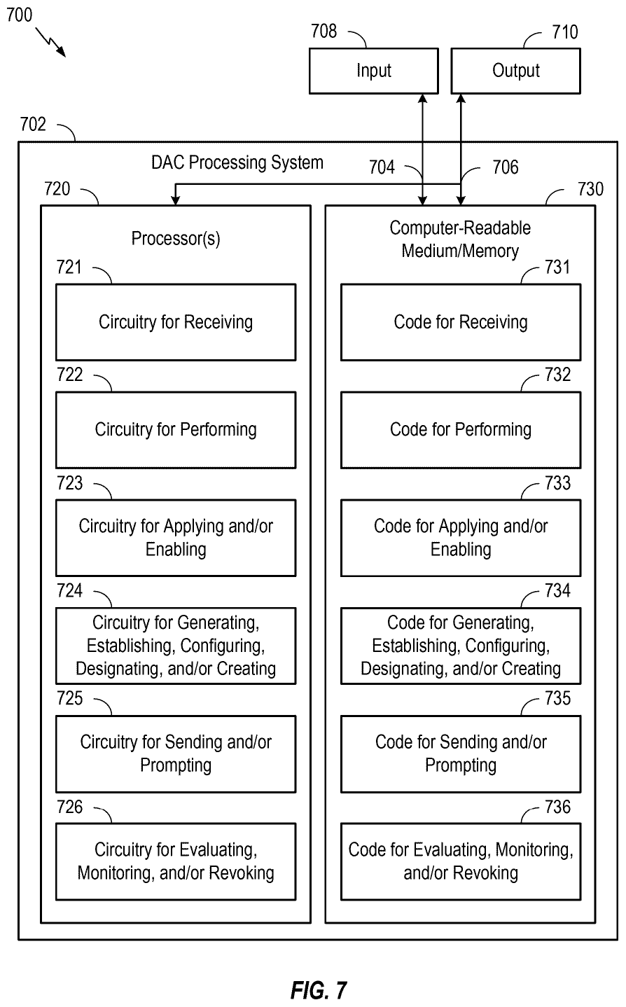

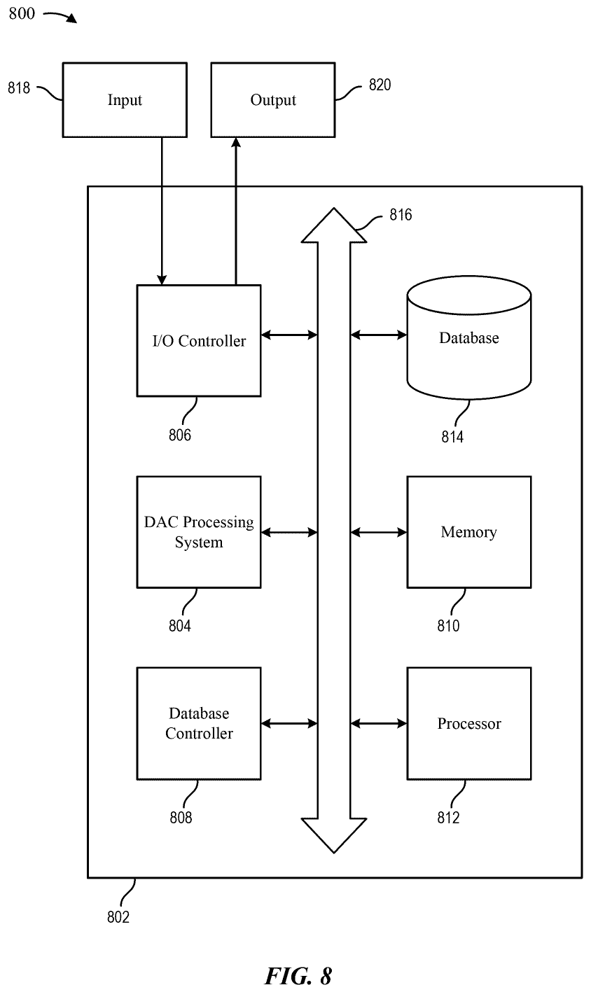

In certain aspects, method 500, or any aspect related to it, may be performed by an apparatus, such as an apparatus 700 of FIG. 7, an apparatus 800 of FIG. 8, a user terminal, a database server, a system containing multiple computing devices, a cloud client 102 as described with reference to FIG. 1, and/or another device, which includes various components operable, configured, or adapted to perform the method 500. The device 700 and the device 800 are described below in further detail.

Note that FIG. 5 is just one example of a method, and other methods including fewer, additional, or alternative operations are possible consistent with this disclosure.

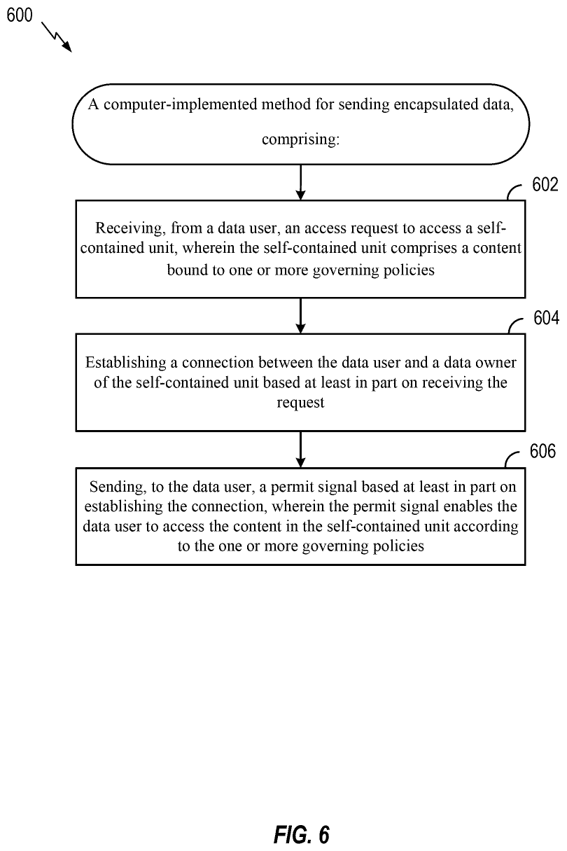

FIG. 6 depicts a method 600 for sending encapsulated data in accordance with aspects of the present disclosure. In some aspects, the method 600 may be performed by an apparatus, such as a user terminal, a database server, or a system containing multiple computing devices and/or a cloud client 102 as described with reference to FIG. 1 and/or another device.

Method 600 begins at block 602 with receiving, from a user, an access request to access a self-contained unit, wherein the self-contained unit comprises a content bound to one or more governing policies.

Method 600 then proceeds to block 604 with establishing a connection between the user and a content owner of the self-contained unit based at least in part on receiving the request.

Method 600 then proceeds to block 606 with sending, to the user, a permit signal based at least in part on establishing the connection, wherein the permit signal enables the user to access the content in the self-contained unit according to the one or more governing policies.

In certain aspects, method 600 further includes sending, to the user, an indication that the self-contained unit is secured.

In certain aspects, method 600 further includes prompting the user to create a user identifier and to install a data management system agent on a device of the user.

In certain aspects, method 600 further includes sending, to the user, an indication to identify the content owner.

In certain aspects, method 600 further includes sending, to the content owner, the access request based at least in part on the user correctly identifying the content owner.

In certain aspects, method 600 further includes receiving, from the content owner, a confirmation that the user is granted access to the self-contained unit.

In certain aspects, method 600 further includes sending, to the user, terms and conditions for accessing the self-contained unit.

In certain aspects, method 600 further includes receiving, from the user, an indication that the user agrees to the terms and conditions.

In certain aspects, the terms and conditions comprise information on how the content in the self-contained unit can be accessed, shared, and utilized by the user.

In certain aspects, the terms and conditions correspond to the one or more governing policies of the self-contained unit.

In certain aspects, method 600 further includes configuring a device of the user to comply with the one or more governing policies for accessing the content in the self-contained unit.

In certain aspects, method 600 further includes enabling, on the device, continuous monitoring of one or more interactions made by the user with respect to the content in the self-contained unit.

In certain aspects, method 600 further includes evaluating whether the one or more interactions comply with the one or more governing policies for accessing the content in the self-contained unit.

In certain aspects, method 600 further includes performing a cryptographic negotiation with a device of the user, wherein the cryptographic negotiation enables the device of the user to decrypt and access the content in the self-contained unit.

In certain aspects, method 600 further includes continuously monitoring whether the user is complying with the one or more governing policies while accessing the content in the self-contained unit.

In certain aspects, method 600 further includes determining whether the user is accessing the content in the self-contained unit according to the one or more governing policies.

In certain aspects, method 600 further includes receiving one or more compliance reports from a device of the user.

In certain aspects, method 600 further includes revoking access to the self-contained unit for the user based at least in part on the user not complying with the one or more governing policies while accessing the content in the self-contained unit, the user not sending a compliance report, or a combination thereof.

In certain aspects, method 600 further includes refraining from sending the permit signal to a device of the user, wherein refraining from sending the permit signal results in the self-contained unit being placed in a deny access state for the user.

In certain aspects, method 600 further includes receiving an indication that the user is attempting to create derivative content from the content in the self-contained unit.

In certain aspects, method 600 further includes determining whether creation of the derivative content is allowable based at least in part on the one or more governing policies of the self-contained unit.

In certain aspects, method 600 further includes creating an additional self-contained unit based at least in part on creation of the derivative content being allowable, wherein the additional self-contained unit comprises the derivative content bound to the one or more governing policies of the self-contained unit.

In certain aspects, method 600 further includes sending, to the user, an additional permit signal, wherein the additional permit signal enables the user to access the derivative content in the additional self-contained unit according to the one or more governing policies.

In certain aspects, method 600 further includes receiving, from the content owner, an indication that the additional self-contained unit is approved to be created.

In certain aspects, the derivative content comprises modified content in the self-contained unit.

In certain aspects, the one or more governing policies comprise license terms and conditions, usage rules, lifecycle management instructions, contractual terms, or a combination thereof for the self-contained unit.

In certain aspects, the content comprises data and one or more functions for the data.

In certain aspects, the content comprises textual content, visual content, audio content, software, source code, or another type of content.

In certain aspects, method 600, or any aspect related to it, may be performed by an apparatus, such as an apparatus 700 of FIG. 7, an apparatus 800 of FIG. 8, a user terminal, a database server, a system containing multiple computing devices, a cloud client 102 as described with reference to FIG. 1, and/or another device, which includes various components operable, configured, or adapted to perform the method 600. The device 700 and the device 800 are described below in further detail.

Note that FIG. 6 is just one example of a method, and other methods including fewer, additional, or alternative operations are possible consistent with this disclosure.

FIG. 7 depicts aspects of an example apparatus 700. In some aspects, apparatus 700 may be a user terminal, a database server, a system containing multiple computing devices, a cloud client 102 as described with reference to FIG. 1, and/or another device.

The apparatus 700 includes a DAC processing system 702 coupled to an input module 708 and an output module 710. The input module 708 may manage input signals for the apparatus 700. For example, the input module 708 may identify input signals based on an interaction with a modem, a keyboard, a mouse, a touchscreen, or a similar device. These input signals may be associated with user input or processing at other components or devices. In some cases, the input module 708 may utilize an operating system such as IOS®, ANDROID®, MS-DOS®, MS-WINDOWS®, OS/2, UNIX®, LINUX®, or another known operating system to handle input signals.

The input module 708 may send aspects of these input signals to other components of the apparatus 700 for processing. For example, the input module 708 may transmit input signals to the DAC processing system 702 to support encapsulating content with defined governing logic for the content. In some cases, the input module 708 may be a component of an input/output (I/O) controller 806 as described with reference to FIG. 8.

The output module 710 may manage output signals for the apparatus 700. For example. the output module 710 may receive signals from other components of the apparatus 700, such as the DAC processing system 702, and may transmit these signals to other components or devices. In some specific examples, the output module 710 may transmit output signals for display in a user interface, for storage in a database or data store, for further processing at a server or server cluster, or for any other processes at any number of devices or systems. In some cases, the output module 710 may be a component of an I/O) controller 806 as described with reference to FIG. 8

The DAC processing system 702 may be configured to perform processing functions for the apparatus 700, including processing signals received and/or to be transmitted by the apparatus 700.

The DAC processing system 702 includes one or more processors 720. The one or more processors 720 are coupled to a computer-readable medium/memory 730 via a bus 704 and/or a bus 706. In certain aspects, the computer-readable medium/memory 730 is configured to store instructions (e.g., computer-executable code) that when executed by the one or more processors 720, enable and cause the one or more processors 720 to perform the method 500 described with respect to FIG. 5 and/or the method 600 described with reference to FIG. 6, or any aspect related to it, including any operations described in relation to FIGS. 5 and 6. Note that reference to a processor performing a function of apparatus 700 may include one or more processors performing that function of apparatus 700, such as in a distributed fashion.

In the depicted example, computer-readable medium/memory 730 stores code for receiving 731; code for performing 732; code for applying and/or enabling 733; code for generating, establishing, configuring, designating, and/or creating 734; code for sending and/or prompting 735; and code for evaluating, monitoring, and/or revoking 736. Processing of the code 731-736 may enable and cause the apparatus 700 to perform the method 500 described with respect to FIG. 5 and/or the method 600 described with respect to FIG. 6, or any aspect related to it.

The one or more processors 720 include circuitry configured to implement (e.g., execute) the code stored in the computer-readable medium/memory 730, including circuitry for receiving 721; circuitry for performing 722; circuitry for applying and/or enabling 723; circuitry for generating, establishing, configuring, designating, and/or creating 724; circuitry for sending and/or prompting 725; and circuitry for evaluating, monitoring, and/or revoking 726. Processing with circuitry 721-726 may enable and cause the apparatus 700 to perform the method 500 described with respect to FIG. 5 and/or the method 600 described with respect to FIG. 6, or any aspect related to it.

More generally, means for receiving, performing, applying, enabling, generating, establishing, configuring, designating, creating, sending, prompting, evaluating, monitoring, and/or revoking may include transceivers, antenna(s), transmit processors, AI processors, a controller, and/or a processor of the apparatus 700 and/or one or more processors 812 of the device 802 in FIG. 8.

FIG. 8 depicts a diagram of a system 800 including a device 802 that supports encapsulating content with defined governing logic for the content in accordance with aspects of the present disclosure The device 802 may be an example of or include the components of a source database or an apparatus 700 as described herein. The device 802 may include components for bi-directional data communications including components for transmitting and receiving communications, including a DAC processing system 804, an I/O controller 806, a database controller 808, memory 810, a processor 812, and a database 814. These components may be in electronic communication via one or more buses (e.g, bus 816).

The DAC processing system 804 may be an example of a DAC processing system 702 as described herein For example, the DAC processing system 804 may implement and/or perform any of the methods, systems, or processes described above with reference to FIGS. 3-6. In some cases, the DAC processing system 804 may be implemented in hardware, software executed by a processor, firmware, or any combination thereof.

The I/O) controller 806 may manage input signals 818 and output signals 820 for the device 802. The I/O controller 806 may also manage peripherals not integrated into the device 802. In some cases, the I/O controller 806 may represent a physical connection or port to an external peripheral. In some cases, the I/O controller 806 may utilize an operating system such as iOS®, ANDROID®, MS-DOS®, MS-WINDOWS®, OS/2®, UNIX®, LINUX®, or another known operating system. In other cases, the I/O controller 806 may represent or interact with a modem, a keyboard, a mouse, a touchscreen, or a similar device. In some cases, the I/O controller 806 may be implemented as part of a processor. In some cases, a user may interact with the device 802 via the I/O controller 806 or via hardware components controlled by the I/O controller 806

The database controller 808 may manage data storage and processing in a database 814. In some cases, a user may interact with the database controller 808. In other cases, the database controller 808 may operate automatically without user interaction. The database 814 may be an example of a single database, a distributed database, multiple distributed databases, a data store, a data lake, or an emergency backup database.

Memory 810 may include random-access memory (RAM) and read-only memory (ROM). The memory 810 may store computer-readable, computer-executable software including instructions that, when executed, cause the processor to perform various functions described herein. In some cases, the memory 810 may contain, among other things, a basic input/output system (BIOS) which may control basic hardware or software operation such as the interaction with peripheral components or devices.

The processor 812 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof) In some cases, the processor 812 may be configured to operate a memory array using a memory controller. In other cases, a memory controller may be integrated into the processor 812. The processor 812 may be configured to execute computer-readable instructions stored in a memory 810 to perform various functions (e.g., functions or tasks supporting data encapsulation and/or sending encapsulated content).

In some embodiments. computer-implemented method for data encapsulation includes: receiving, from a content owner, an indication of content; receiving, from the content owner, one or more governance policies corresponding to the content, wherein the one or more governance polices comprise one or more parameters for accessing, sharing, utilizing, or a combination thereof, of the content; and performing an encapsulation process to bind the content with the one or more governance policies into a self-contained unit

In some embodiments, the method also includes: performing, prior to the encapsulation process, a first encryption process on the content; and performing, prior to the encapsulation process, a second encryption process on the one or more governance policies. In some embodiments, the first encryption process and the second encryption process comprise a fully homomorphic encryption (FHE) algorithm or another encryption algorithm. In some embodiments, the method also includes applying a cryptographic signature from the content owner to the one or more governance policies. In some embodiments. the content is inseparable from the one or more governance policies in the self-contained unit based at least in part on performing the encapsulation process; and the one or more governance policies are enforced for the self-contained unit at a data level based at least in part on performing the encapsulation process. In some embodiments, the method also includes generating one or more unique cryptographic keys for the self-contained unit, wherein the one or more unique cryptographic keys are generated based at least in part on an identifier corresponding to the content owner, the content in the self-contained unit, or a combination thereof. In some embodiments, the method also includes: performing, at a first layer, a first encryption process on a contract based at least in part on the one or more unique cryptographic keys, wherein the contract is configured to enforce the one or more governance polices; and performing, at a second layer, a second encryption process on an access agreement based at least in part on the one or more unique cryptographic keys, wherein the access agreement is configured to enable access to the self-contained unit. In some embodiments, the method also includes establishing one or more communication channels via a secure communication protocol, wherein the one or more communication channels are configured for exchanging compliance and permission signaling to enable access to the self-contained unit. In some embodiments, the secure communication protocol comprises a transport layer security (TLS) protocol or another secure communication protocol. In some embodiments, the method also includes configuring one or more access gateways to integrate the self-contained unit with one or more external systems. In some embodiments, the one or more external systems comprise an application programming interface (API) system or another external system. In some embodiments, the method also includes designating the self-contained unit for deployment, wherein designating the self-contained unit for deployment comprises indicating the self-contained unit is available for access to a user according to the one or more governing policies. In some embodiments, the method also includes creating an identifier for the self-contained unit. In some embodiments, the method also includes receiving, from the content owner, an indication of the identifier for the self-contained unit. In some embodiments, the one or more governing policies comprise license terms and conditions, usage rules, lifecycle management instructions, contractual terms, or a combination thereof for the self-contained unit. In some embodiments, the method also includes sending, to a user, the self-contained unit. In some embodiments, the self-contained unit is sent via a secure communication protocol. In some embodiments, the content comprises data and one or more functions for the data. In some embodiments, the content comprises textual content, visual content, audio content, software, source code, or another type of content

In some embodiments, a computer-implemented method for sending encapsulated content incudes: receiving, from a user, an access request to access a self-contained unit, wherein the self-contained unit comprises a content bound to one or more governing policies; establishing a connection between the user and a content owner of the self-contained unit based at least in part on receiving the request; and sending, to the user, a permit signal based at least in part on establishing the connection, wherein the permit signal enables the user to access the content in the self-contained unit according to the one or more governing policies.

In some embodiments, the method also includes sending, to the user, an indication that the self-contained unit is secured. In some embodiments, the method also includes prompting the user to create a user identifier and to install a data management system agent on a device of the user. In some embodiments, establishing the connection between the user and the content owner further comprises: sending, to the user, an indication to identify the content owner; sending, to the content owner, the access request based at least in part on the user correctly identifying the content owner, and receiving, from the content owner, a confirmation that the user is granted access to the self-contained unit. In some embodiments, the method also includes: sending, to the user, terms and conditions for accessing the self-contained unit; and receiving, from the user, an indication that the user agrees to the terms and conditions. In some embodiments, the terms and conditions comprise information on how the content in the self-contained unit can be accessed, shared, and utilized by the user. In some embodiments, the terms and conditions correspond to the one or more governing policies of the self-contained unit. In some embodiments, the method also includes configuring a device of the user to comply with the one or more governing policies for accessing the content in the self-contained unit. In some embodiments, configuring the device of the user further comprises: enabling, on the device, continuous monitoring of one or more interactions made by the user with respect to the content in the self-contained unit; and evaluating whether the one or more interactions comply with the one or more governing policies for accessing the content in the self-contained unit. In some embodiments, the method also includes performing a cryptographic negotiation with a device of the user, wherein the cryptographic negotiation enables the device of the user to decrypt and access the content in the self-contained unit. In some embodiments, the method also includes continuously monitoring whether the user is complying with the one or more governing policies while accessing the content in the self-contained unit. In some embodiments, continuously monitoring whether the user is complying with the one or more governing policies further comprises: determining whether the user is accessing the content in the self-contained unit according to the one or more governing policies; and receiving one or more compliance reports from a device of the user In some embodiments, the method also includes revoking access to the self-contained unit for the user based at least in part on the user not complying with the one or more governing policies while accessing the content in the self-contained unit, the user not sending a compliance report, or a combination thereof. In some embodiments, revoking access to the self-contained unit further comprises refraining from sending the permit signal to a device of the user, wherein refraining from sending the permit signal results in the self-contained unit being placed in a deny access state for the user. In some embodiments, the method also includes: receiving an indication that the user is attempting to create derivative content from the content in the self-contained unit; determining whether creation of the derivative content is allowable based at least in part on the one or more governing policies of the self-contained unit; creating an additional self-contained unit based at least in part on creation of the derivative content being allowable, wherein the additional self-contained unit comprises the derivative content bound to the one or more governing policies of the self-contained unit; and sending, to the user, an additional permit signal, wherein the additional permit signal enables the user to access the derivative content in the additional self-contained unit according to the one or more governing policies. In some embodiments, the method also includes receiving, from the content owner, an indication that the additional self-contained unit is approved to be created. In some embodiments, the derivative content comprises modified content in the self-contained unit. In some embodiments, the one or more governing policies comprise license terms and conditions, usage rules, lifecycle management instructions, contractual terms, or a combination thereof for the self-contained unit In some embodiments, the content comprises data and one or more functions for the data In some embodiments, the content comprises textual content, visual content, audio content, software, source code, or another type of content.

In some embodiments, a method for data encapsulation includes: receiving, at a user interface, an indication of content associated with a content owner; receiving one or more governance policies corresponding to the content, wherein the one or more governance polices include one or more parameters, the one or more parameters defining parameter characteristics of the content and include at least one of an accessing parameter, a sharing parameter, and a utilizing parameter; generating at least one data object based on the content and the one or more parameters; and performing an encapsulation process to bind the at least one data object with the one or more governance policies into an digital agency capsule.

In some embodiments, the method also includes. performing, prior to the encapsulation process, a first encryption process on the data object; and performing, prior to the encapsulation process, a second encryption process on the one or more governance policies. In some embodiments, the first encryption process and the second encryption process include at least one of a fully homomorphic encryption (FHE) algorithm and another encryption algorithm In some embodiments, the method also includes applying a cryptographic signature from the content owner to the one or more governance policies. In some embodiments. the content is inseparable from the one or more governance policies in the digital agency capsule based at least in part on performing the encapsulation process; and the one or more governance policies are enforced for the digital agency capsule at a data level based at least in part on performing the encapsulation process. In some embodiments, the method also includes generating one or more unique cryptographic keys for the digital agency capsule, wherein the one or more unique cryptographic keys are generated based at least in part on at least one of an identifier corresponding to the content owner, and the content in the digital agency capsule. In some embodiments, the method also includes: performing, at a first layer, a first encryption process on a contract based at least in part on the one or more unique cryptographic keys, wherein the contract is configured to enforce the one or more governance polices; and performing, at a second layer, a second encryption process on an access agreement based at least in part on the one or more unique cryptographic keys, wherein the access agreement is configured to enable access to the digital agency capsule. In some embodiments, the method also includes establishing one or more communication channels via a secure communication protocol, wherein the one or more communication channels are configured for exchanging compliance and permission signaling to enable access to the digital agency capsule. In some embodiments, the secure communication protocol includes at least one of a transport layer security (TLS) protocol and another secure communication protocol. In some embodiments, the method also includes configuring one or more access gateways to integrate the digital agency capsule with one or more external systems. In some embodiments, the one or more external systems includes at least one of an application programming interface (API) system and another external system.

In some embodiments, a system for data encapsulation includes: a processor, and a memory. The memory includes instructions that, when executed by the processor, cause the processor to: receive, at a user interface, an indication of content associated with a content owner; receive one or more governance policies (e.g., and/or the associated rules, which are the instrumented actions for how the policies are performed on the user's platform to ensure compliance with the policies) corresponding to the content, wherein the one or more governance polices include one or more parameters, the one or more parameters defining parameter characteristics of the content and include at least one of an accessing parameter, a sharing parameter, and a utilizing parameter; generate at least one data object based on the content and the one or more parameters; and perform an encapsulation process to bind the at least one data object with the one or more governance policies into an digital agency capsule.

In some embodiments, the instructions further cause the processor to: perform, prior to the encapsulation process, a first encryption process on the data object; and perform, prior to the encapsulation process, a second encryption process on the one or more governance policies (e.g., and/or one or more objects, each of these are encrypted and the object encryption includes the governance policy as one encryption, and then all of the encrypted objects are collected and a governance policy is set at the digital agency capsule level, which is also encrypted). In some embodiments, the first encryption process and the second encryption process include at least one of a fully homomorphic encryption (FHE) algorithm and another encryption algorithm (e.g., and/or any suitable encryption technique or a combination thereof). In some embodiments, the instructions further cause the processor to apply a cryptographic signature from the content owner to the one or more governance policies. In some embodiments: the content is inseparable from the one or more governance policies in the digital agency capsule based at least in part on performing the encapsulation process; and the one or more governance policies are enforced for the digital agency capsule at a data level based at least in part on performing the encapsulation process In some embodiments, the instructions further cause the processor to generate one or more unique cryptographic keys for the digital agency capsule, wherein the one or more unique cryptographic keys are generated based at least in part on at least one of an identifier corresponding to the content owner, and the content in the digital agency capsule. In some embodiments, the instructions further cause the processor to: perform, at a first layer, a first encryption process on a contract based at least in part on the one or more unique cryptographic keys, wherein the contract is configured to enforce the one or more governance polices; and perform, at a second layer, a second encryption process on an access agreement based at least in part on the one or more unique cryptographic keys, wherein the access agreement is configured to enable access to the digital agency capsule. In some embodiments, the instructions further cause the processor to establish one or more communication channels via a secure communication protocol, wherein the one or more communication channels are configured for exchanging compliance and permission signaling to enable access to the digital agency capsule.

In some embodiments, an apparatus for sending encapsulated content includes: a computing device configured to: receive an access request to access a digital agency capsule, wherein the digital agency capsule includes a data object associated with content bound to one or more governing policies; establish a connection between a user computing device and a content owner computing device based at least in part on receiving the request, the content owner computing device being associated with an owner of the digital agency capsule; and transmit, to the user computing device, a permit signal based at least in part on establishing the connection, wherein the permit signal enables a user of the user computing device to access the content in the digital agency capsule according to the one or more governing policies.

The preceding description is provided to enable any person skilled in the art to practice the various aspects described herein. The examples discussed herein are not limiting of the scope, applicability, or aspects set forth in the claims Various modifications to these aspects will be readily apparent to those skilled in the art, and the general principles defined herein may be applied to other aspects For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.”

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. A method for data encapsulation, the method comprising:
receiving, at a user interface, an indication of content associated with a content owner;
receiving one or more governance policies corresponding to the content, wherein the one or more governance polices include one or more parameters, the one or more parameters defining parameter characteristics of the content and include at least one of an accessing parameter, a sharing parameter, and a utilizing parameter;
generating at least one data object based on the content and the one or more parameters; and
performing an encapsulation process to bind the at least one data object with the one or more governance policies into a digital agency capsule.

2. The method of claim 1, further comprising:
performing, prior to the encapsulation process, a first encryption process on the data object; and
performing, prior to the encapsulation process, a second encryption process on the one or more governance policies.

3. The method of claim 2, wherein the first encryption process and the second encryption process include at least one of a fully homomorphic encryption (FHE) algorithm and another encryption algorithm.

4. The method of claim 1, further comprising applying a cryptographic signature from the content owner to the one or more governance policies.

5. The method of claim 1, wherein:
the content is inseparable from the one or more governance policies in the digital agency capsule based at least in part on performing the encapsulation process; and
the one or more governance policies are enforced for the digital agency capsule at a data level based at least in part on performing the encapsulation process.

6. The method of claim 1, further comprising generating one or more unique cryptographic keys for the digital agency capsule, wherein the one or more unique cryptographic keys are generated based at least in part on at least one of an identifier corresponding to the content owner, and the content in the digital agency capsule.

7. The method of claim 6, further comprising:
performing, at a first layer, a first encryption process on a contract based at least in part on the one or more unique cryptographic keys, wherein the contract is configured to enforce the one or more governance polices; and
performing, at a second layer, a second encryption process on an access agreement based at least in part on the one or more unique cryptographic keys, wherein the access agreement is configured to enable access to the digital agency capsule.

8. The method of claim 1, further comprising establishing one or more communication channels via a secure communication protocol, wherein the one or more communication channels are configured for exchanging compliance and permission signaling to enable access to the digital agency capsule.

9. The method of claim 8, wherein the secure communication protocol includes at least one of a transport layer security (TLS) protocol and another secure communication protocol.

10. The method of claim 1, further comprising configuring one or more access gateways to integrate the digital agency capsule with one or more external systems.

11. The method of claim 10, wherein the one or more external systems includes at least one of an application programming interface (API) system and another external system.

12. A system for data encapsulation, the system comprising:
a processor; and
a memory including instructions that, when executed by the processor, cause the processor to:
receive, at a user interface, an indication of content associated with a content owner;
receive one or more governance policies corresponding to the content, wherein the one or more governance polices include one or more parameters, the one or more parameters defining parameter characteristics of the content and include at least one of an accessing parameter, a sharing parameter, and a utilizing parameter;
generate at least one data object based on the content and the one or more parameters; and
perform an encapsulation process to bind the at least one data object with the one or more governance policies into a digital agency capsule.

13. The system of claim 12, wherein the instructions further cause the processor to:
perform, prior to the encapsulation process, a first encryption process on the data object; and
perform, prior to the encapsulation process, a second encryption process on the one or more governance policies.

14. The system of claim 13, wherein the first encryption process and the second encryption process include at least one of a fully homomorphic encryption (FHE) algorithm and another encryption algorithm.

15. The system of claim 12, wherein the instructions further cause the processor to apply a cryptographic signature from the content owner to the one or more governance policies.

16. The system of claim 12, wherein:
the content is inseparable from the one or more governance policies in the digital agency capsule based at least in part on performing the encapsulation process; and
the one or more governance policies are enforced for the digital agency capsule at a data level based at least in part on performing the encapsulation process.

17. The system of claim 12, wherein the instructions further cause the processor to generate one or more unique cryptographic keys for the digital agency capsule, wherein the one or more unique cryptographic keys are generated based at least in part on at least one of an identifier corresponding to the content owner, and the content in the digital agency capsule.

18. The system of claim 17, wherein the instructions further cause the processor to:
perform, at a first layer, a first encryption process on a contract based at least in part on the one or more unique cryptographic keys, wherein the contract is configured to enforce the one or more governance polices; and
perform, at a second layer, a second encryption process on an access agreement based at least in part on the one or more unique cryptographic keys, wherein the access agreement is configured to enable access to the digital agency capsule.

19. The system of claim 12, wherein the instructions further cause the processor to establish one or more communication channels via a secure communication protocol, wherein the one or more communication channels are configured for exchanging compliance and permission signaling to enable access to the digital agency capsule.

20. An apparatus for sending encapsulated content, the apparatus comprising:
a computing device configured to:
receive an access request to access a digital agency capsule, wherein the digital agency capsule includes a data object associated with content bound to one or more governing policies;
establish a connection between a user computing device and a content owner computing device based at least in part on receiving the request, the content owner computing device being associated with an owner of the digital agency capsule; and
transmit, to the user computing device, a permit signal based at least in part on establishing the connection, wherein the permit signal enables a user of the user computing device to access the content in the digital agency capsule according to the one or more governing policies.
